(19) United States
(12) Patent Application Publication
(10) Pub. No.: US 2013/0062013 A1
(43) Pub. Date: Mar. 14, 2013

(54) JOINT APPARATUS, JOINT SYSTEM, AND JOINT METHOD

(71) Applicants: Shinji OKADA, Kikuchi-gun (JP); Masatoshi SHIRAISHI, Kikuchi-gun (JP); Masatoshi DEGUCHI, Kikuchi-gun (JP); Naoto YOSHITAKA, Koshi City (JP); Shintaro SUGIHARA, Koshi City (JP); Masataka MATSUNAGA, Koshi City (JP)

(72) Inventors: Shinji OKADA, Kikuchi-gun (JP); Masatoshi SHIRAISHI, Kikuchi-gun (JP); Masatoshi DEGUCHI, Kikuchi-gun (JP); Naoto YOSHITAKA, Koshi City (JP); Shintaro SUGIHARA, Koshi City (JP); Masataka MATSUNAGA, Koshi City (JP)

(73) Assignee: TOKYO ELECTRON LIMITED, Tokyo (JP)

(21) Appl. No.: 13/609,757

(22) Filed: Sep. 11, 2012

(30) Foreign Application Priority Data
Sep. 13, 2011 (JP) 2011-199509

(51) Int. Cl. C09J 5/06

(52) U.S. Cl. 156/322; 156/382

(57) ABSTRACT

A joint apparatus that joins a processing target substrate and a supporting substrate together, includes: a processing container that is capable of hermetically closing an inside thereof; a joint unit that joins the processing target substrate and the supporting substrate together by pressing the processing target substrate and the supporting substrate via an adhesive; and a superposed substrate temperature regulation unit that temperature-regulates a superposed substrate joined in the joint unit, wherein the joint unit and the superposed substrate temperature regulation unit are arranged in the processing container, A delivery unit for delivering the processing target substrate, the supporting substrate, or the superposed substrate to/from an outside of the processing container is provided in the processing container, and the superposed substrate temperature regulation unit is provided in the delivery unit.

### BACKGROUND OF THE INVENTION

1. Field of the Invention

The present invention relates to a joint apparatus that joins a processing target substrate and a supporting substrate together, a joint system. includes the joint apparatus, and a joint method using the joint apparatus.

2. Description of the Related Art

In recent years, for example, in a manufacturing process of a semiconductor device, the diameter of a semiconductor wafer (hereinafter, referred to as a “wafer”) increasingly becomes larger. Further, the wafer is required to be thinner in a specific process such as packaging. For example, when a thin wafer with a large diameter is transferred or subjected to polishing processing as it is, warpage or break can occur in the wafer. Therefore, in order to reinforce the wafer, for example, bonding the wafer to a wafer being a supporting substrate or a glass substrate is performed.

The bonding of the wafer and the supporting substrate is performed by intervening an adhesive between the wafer and the supporting substrate using, for example, a bonding apparatus. The bonding apparatus has, for example, a first holding member that holds the wafer, a second holding member that holds the supporting substrate, a heating mechanism that heats the adhesive disposed between the wafer and the supporting substrate, and a moving mechanism that moves at least the first holding member or the second holding member in the vertical direction. In the bonding apparatus, the adhesive is supplied between the wafer and the supporting substrate and heated, and then the wafer and the supporting substrate are pressed to be joined together (Japanese Laid-open Patent Publication No. 2008-182016).

The wafer joined with the supporting substrate is then transferred from the aforementioned bonding apparatus, for example, to a polishing processing apparatus provided outside the bonding apparatus and subjected to polishing processing.

### SUMMARY OF THE INVENTION

However, the thickness of the wafer after the polishing processing does not become uniform within the wafer but the wafer becomes partially thick or thin in some cases.

From earnest study by the present inventors about this point, it is is found that warpage or distortion occurs in the wafer at the stage before the polishing processing, and the polishing processing performed in this state causes variations in thickness of the wafer after the polishing.

Hence, further investigation about the warpage or distortion shows that the warpage or distortion occurs in the process of transferring the wafer after joining. Usually, the wafer transfer apparatus that transfers the wafer is configured such that the contact area thereof when holding the wafer becomes as small as possible so as not to contaminate the wafer with particles or the like adhering to the wafer transfer apparatus in the transfer process. On the other hand, the wafer after joining is kept at a high temperature due to the heat when heating the adhesive. Therefore, a portion of the wafer after joining which is not held by the wafer transfer apparatus is warped or distorted.

Accordingly, to prevent occurrence of warpage or distortion in the wafer after joining, it is preferable to cool the wafer to a temperature causing no warpage or distortion before transferring the wafer after joining.

The present invention has been made in view of the above points and its object is to suppress occurrence of warpage or distortion in a wafer joined with a superposed substrate.

To achieve the above object, the present invention is a joint apparatus that joins a processing target substrate and a supporting substrate together, including: a processing container that is capable of hermetically closing an inside thereof; a joint unit that joins the processing target substrate and the supporting substrate together by pressing the processing target substrate and the supporting substrate via an adhesive; and a superposed substrate temperature regulation unit that temperature-regulates a superposed substrate joined in the joint unit, wherein the joint unit and the superposed substrate temperature regulation unit are arranged in the processing container.

According to the joint apparatus of the present invention, the joint unit and the superposed substrate temperature regulation unit that temperature-regulates the superposed substrate joined in the joint unit are arranged in the processing container, so that the superposed substrate can be cooled down to a temperature causing no warpage or distortion before the superposed substrate is transferred outside the processing container. This makes it possible to suppress occurrence of warpage or distortion in the processing target substrate joined with the supporting substrate.

The present invention according to another aspect is a joint system including a joint apparatus that joins a processing target substrate and a supporting substrate together, the joint apparatus including: a processing container that is capable of hermetically closing an inside thereof; a joint unit that joins the processing target substrate and the supporting substrate together by, pressing the processing target substrate and the supporting substrate via an adhesive; and a superposed substrate temperature regulation unit that temperature-regulates a superposed substrate joined in the joint unit, wherein the joint unit and the superposed substrate temperature regulation unit are arranged in the processing container, the joint system including: a joint processing station including the joint apparatus, a coating apparatus that applies the adhesive to the processing target substrate or the supporting substrate, a thermal processing apparatus that heats the processing target substrate or the supporting substrate to which the adhesive has been applied to a predetermined temperature, and a transfer region for transferring the processing target substrate, the supporting substrate, or the superposed substrate to the coating apparatus, the thermal processing apparatus, and the joint apparatus; and a transfer-in/out station that transfers the processing target substrate, the supporting substrate, or the superposed substrate in which. the processing target substrate and the supporting substrate are joined. together, into/out of the joint processing station.

The present invention according to another aspect is a joint method of joining a processing target substrate and a supporting substrate together using a joint apparatus, the joint apparatus including a processing container that is capable of hermetically closing an inside thereof, a joint unit that joins the processing target substrate and the supporting substrate together by pressing the processing target substrate and the supporting substrate via an adhesive, and a superposed substrate temperature regulation unit that temperature-regulates a superposed. substrate joined in the joint unit, wherein the joint unit and the superposed substrate temperature regulation unit are arranged in the processing container, the joint method including: a joint step of joining the processing target substrate to which the adhesive has been applied and which has been heated to a predetermined temperature and the supporting substrate together by pressing the processing target substrate and the supporting substrate in the joint unit; and a temperature regulation step of temperature-regulating the superposed substrate in the super posed substrate temperature regulation unit after the joint step.

According to the present invention, it is possible to suppress occurrence of warpage or distortion in a wafer joined with a superposed substrate.

### BRIEF DESCRIPTION OF THE DRAWINGS

FIG. 1 is a plan view illustrating the outline of a configuration of a joint system according to this embodiment;

FIG. 2 is a side view illustrating the outline of the internal configuration of the joint system according to this embodiment;

FIG. 3 is a side view of a processing target wafer and a supporting wafer;

FIG. 4 is a transverse sectional view illustrating the outline of a configuration of a joint apparatus;

FIG. 5 is a plan view illustrating the outline of a configuration of a delivery unit;

FIG. 6 is a plan view illustrating the outline of a configuration of a delivery arm;

FIG. 7 is a side view illustrating the outline of the configuration of the delivery arm;

FIG. 8 is a plan view illustrating the outline of a configuration of a reversing unit;

FIG. 9 is a side view illustrating the outline of the configuration of the reversing unit;

FIG. 10 is a side view illustrating the outline of the configuration of the reversing unit;

FIG. 11 is a side view illustrating the outline of configurations of a holding arm and holding members;

FIG. 12 is an explanatory view illustrating the positional relation between the delivery unit and the reversing unit ;

FIG. 13 is a side view illustrating the outline of a configuration of a transfer unit;

FIG. 14 is an explanatory view illustrating the appearance in which the transfer unit is disposed inside the joint apparatus;

FIG. 15 is a plan view illustrating the outline of a configuration of a first transfer arm;

FIG. 16 is a side view illustrating the outline of the configuration of the first transfer arm;

FIG. 17 is a plan view illustrating the outline of a configuration of a second transfer arm;

FIG. 18 is a side view illustrating the outline of the configuration of the second transfer arm;

FIG. 19 is an explanatory view illustrating the appearance in which cutouts are formed in the second holding unit;

FIG. 20 is a longitudinal sectional view illustrating the outline of a configuration of a joint unit;

FIG. 21 is a longitudinal sectional view illustrating the outline of the configuration of the joint unit;

FIG. 22 is a longitudinal sectional. view illustrating the outline of a configuration of a coating apparatus;

FIG. 23 is a transverse sectional view illustrating the outline of the configuration of the coating apparatus;

FIG. 24 is a longitudinal sectional view illustrating the outline of a configuration of a thermal processing apparatus;

FIG. 25 is a transverse sectional view illustrating the outline of the configuration of the thermal processing apparatus;

FIG. 26 is a flowchart illustrating main steps of joint processing;

FIG. 27 is an explanatory view illustrating the appearance in which the first holding unit is raised;

FIG. 28 is an explanatory view illustrating the appearance in which the central portion of the second holding unit bends;

FIG. 29 is an explanatory view illustrating the appearance in which the entire joint surface of the supporting wafer is in abutment with the entire joint surface of the processing target wafer;

FIG. 30 is an explanatory view illustrating the appearance in which the processing target wafer and the supporting wafer are joined together; and

FIG. 31 is a transverse sectional view illustrating the outline of a configuration of a joint apparatus according to another embodiment.

### DETAILED DESCRIPTION OF THE INVENTION

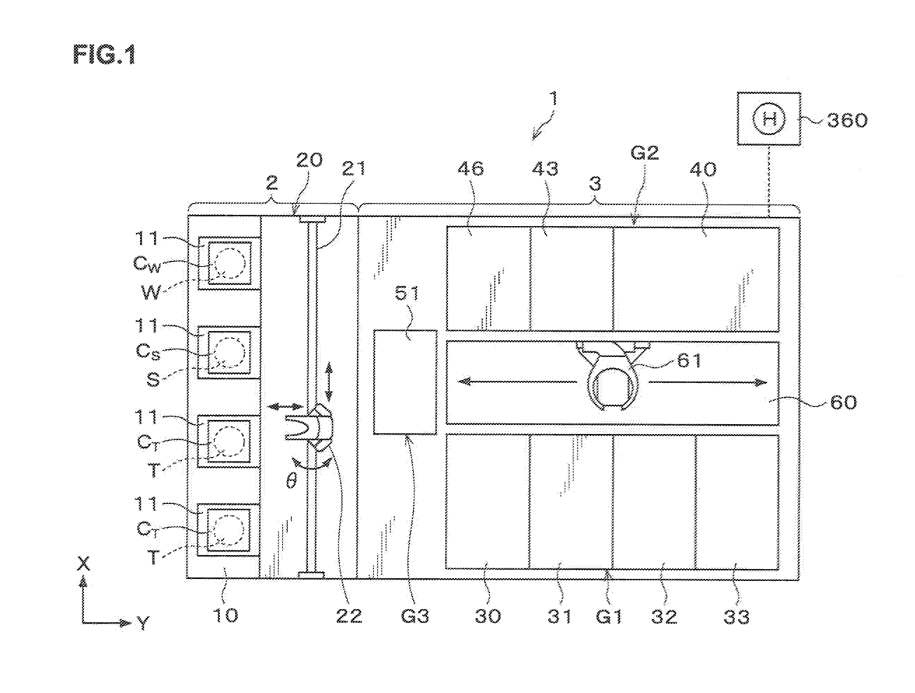

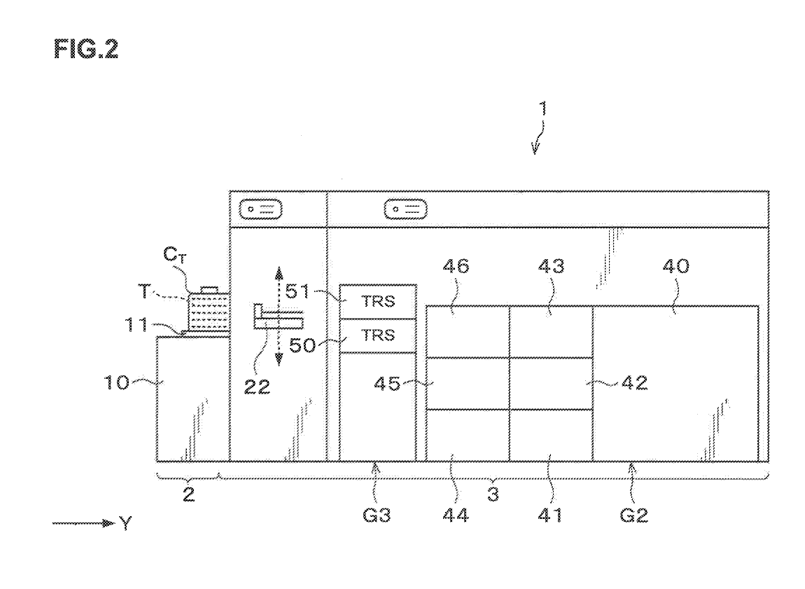

Hereinafter, embodiments of the present invention will be described. FIG. 1 is a plan view illustrating the outline of a configuration of a joint system 1 including a joint apparatus according to this embodiment. FIG. 2 is a side view illustrating the outline of the internal configuration of the joint system 1,

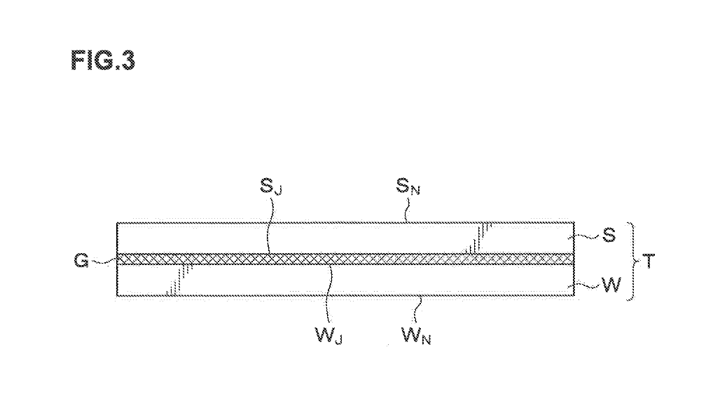

In the joint system 1, for example, a processing target wafer W as a processing target substrate and a supporting wafer S as a supporting substrate are joined together, for example, via an adhesive G as illustrated in FIG. 3. Hereinafter, in the processing target wafer W, the surface to be joined with the supporting wafer S via the adhesive G is referred to as a “joint surface W_{J}” as a front surface and the surface opposite to the joint surface W_{J} is referred to as a “non-joint surface W_{N}” as a rear surface. Similarly, in the supporting wafer S, the surface to be joined with the processing target wafer W via the adhesive G is referred to as a “joint surface S_{J}” as a front surface and the surface opposite to the joint surface S_{J} is referred to as a “non-joint surface S_{N}” as a rear surface. Then, in the joint system 1, the processing target wafer W and the supporting wafer S are joined together to form a superposed wafer T as a superposed substrate. Note that the processing target wafer W is a wafer which will be a product in which a plurality of electronic circuits have been formed, for example, on the joint surface W_{J}, and the non-joint surface W_{N} is subjected to polishing processing. The supporting wafer S is a wafer which has the same diameter as that of the processing target wafer W and supports the processing target wafer W. Note that a case of using a wafer as the supporting substrate will be described in this embodiment, but another substrate such as, for example, a glass substrate or the like may be used.

The joint system 1 has, as illustrated in FIG. 1, a configuration in which a transfer-in/out station 2 into/from which cassettes C_{W}, C_{S}, C_{T} capable of housing a plurality of processing target wafers W, a plurality of supporting wafers 8, and a plurality of superposed wafers respectively are transferred from/to the outside, and a processing station 3 including various processing and treatment apparatuses that perform predetermined processing and treatment on the processing target wafer W, the supporting wafer 8, the superposed wafer T are integrally connected.

In the transfer-in/out station 2, a cassette mounting table 10 is provided. On the cassette mounting table 10, a plurality of; for example, four cassette mounting plates 11 are provided. The cassette mounting plates 11 are arranged side by side in a line in an X-direction (a top-bottom direction in FIG. 1). On the cassette mounting plates 11, the cassettes C_{W}, C_{S}, C_{T} can be mounted when the cassettes C_{W}, C_{S}, C_{T} are transferred in/out from/to the outside of the joint system 1. As described above, the transfer-in/out station 2 is configured to be capable of holding the plurality of processing target wafers W, the plurality of supporting wafers 8, and the plurality of superposed wafers T. Note that the number of cassette mounting plates 11. is not limited to this embodiment but can be arbitrarily determined. Further, one cassette may be used for collecting defective wafers. In other words, the cassette is a cassette that is capable of separating wafers having defects in jointing the processing target wafer W and the supporting wafer S occurred due to various causes, from other normal superposed wafers T. In this embodiment, one cassette C_{T} among the plurality of cassettes C_{T} is used for collecting the defective wafers, and the other cassettes C_{T} are used for housing normal superposed wafers T.

In the transfer-in/out station 2, a wafer transfer apparatus 20 is provided adjacent to the cassette mounting table 10. In the wafer transfer apparatus 20, a wafer transfer apparatus 22 movable on a transfer path 21 extending in the X-direction is provided. The wafer transfer apparatus 22 is movable also in the vertical direction and around the vertical axis (in a θ-direction) and thus can transfer the processing target wafer W, the supporting wafer S, the superposed wafer T between the cassettes C_{W}, C_{S}, C_{T} on the cassette mounting plates 11 and later-described transition apparatuses SO, 51 in a third processing block G3 in the processing station 3.

In the processing station 3, a plurality of, for example, three processing blocks G1, G2, G3 each including various kinds of processing and treatment apparatuses are provided, For example, the first processing block G1 is provided, for example, on the front side in the processing station 3 (on an X-direction negative direction side in FIG. 1), and the second processing block G2 is provided on the back side in the processing station 3 (on an X-direction positive direction side in FIG. 1). Further, the third processing block G3 is provided on the transfer-in/out station 2 side in the processing station 3 (on a Y-direction negative direction side in FIG. 1),

For example, in the first processing block G1, joint apparatuses 30 to 33 each of which presses the processing target wafer W and the supporting wafer S via the adhesive G to join them together are provided side by side in the Y-direction. in this order from the transfer-in/out station 2 side.

For example, in the second processing block G2, a coating apparatus 40 that applies the adhesive G to the processing target wafer W, thermal processing apparatuses 41 to 43 each of which heats the processing target wafer W having the adhesive G applied thereon to a predetermined temperature, and similar thermal processing apparatuses 44 to 46 are arranged side by side in this order in the direction toward the transfer-in/out station 2 side (in the Y-direction negative direction in FIG. 1) as illustrated in FIG. 2. The thermal processing apparatuses 41 to 43 and the thermal processing apparatuses 44 to 46 are provided at three tiers in this order from the bottom. Note that the number and the arrangement in the vertical direction and in the horizontal direction of thermal processing apparatuses 41 to 46 to be installed can be arbitrarily set.

For example, in the third processing block G3, transition apparatuses 50, 51 for the processing target wafer W, the supporting wafer S, the superposed wafer T are provided at two tiers in order from the bottom,

In an area surrounded by the first processing block G1 to the third processing block G3, a wafer transfer region 60 is formed as illustrated in FIG. 1. In the wafer transfer region 60, for example, a wafer transfer apparatus 61 is disposed. Note that the pressure inside the wafer transfer region 60 is equal to or higher than an atmospheric pressure, and transfer of the processing target wafer W, the supporting wafer S, the superposed wafer T in a so-called atmospheric system is performed in the wafer transfer region 60.

The wafer transfer apparatus 61 has a transfer arm movable, for example, in the vertical direction, the horizontal direction (a Y-direction, an X-direction), and around the vertical axis. The wafer transfer apparatus 61 can move in the wafer transfer region 60 to transfer the processing target wafer W, the supporting wafer S, the superposed wafer T to a predetermined apparatus in the first processing block G1, the second processing block G2, and the third processing block G3 therearound.

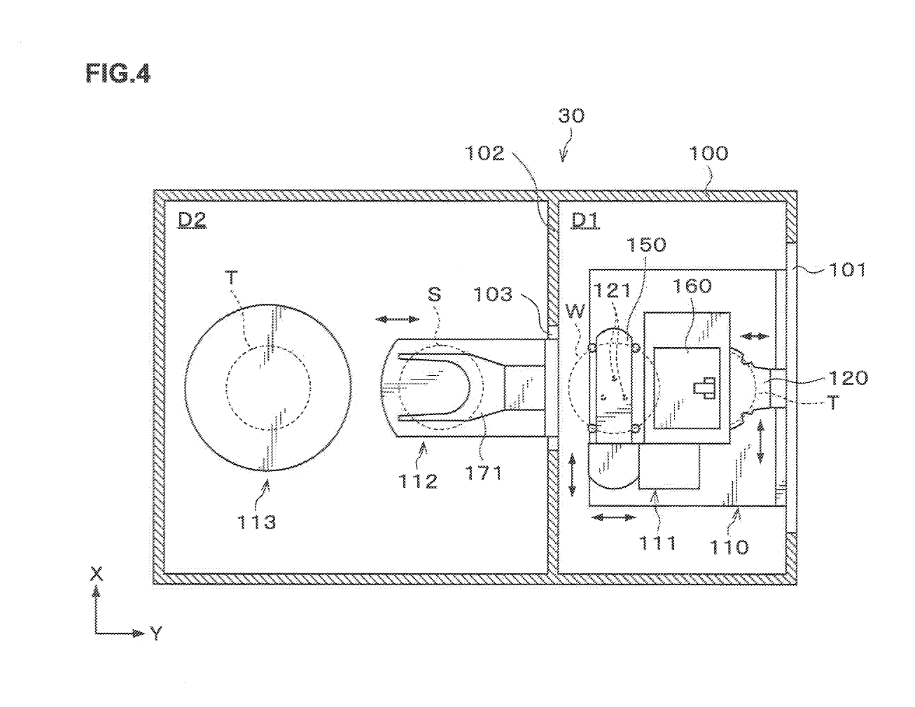

Next, the configurations of the aforementioned joint apparatuses 30 to 33 will be described, The joint apparatus 30 has a processing container 100 which can hermetically close the inside thereof as illustrated in FIG. 4. In the side surface of the processing container 100 on the wafer transfer region 60 side, a transfer-in/out port 101. for the processing target wafer W, the supporting wafer S, the superposed wafer T is formed, and an opening/closing shutter (not illustrated) is provided at the transfer-in/out port.

The inside of the processing container 100 is divided into a pre-processing region D1 and a joint region D2 by an inner wall 102. The aforementioned transfer-in/out port 101 is formed in the side surface of the processing container 100 in the pre-processing region D1. Also in the inner wall 102, a transfer-in/out port 103 for the processing target wafer W, the supporting wafer S, the superposed wafer T is formed.

In the pre-processing region D1, a delivery unit 110 for delivering the processing target wafer W, the supporting wafer 5, the superposed wafer T to/from the outside of the joint apparatus 30 is provided. The delivery unit 110 is disposed adjacent to the transfer-in/out port 101. Further, a plurality of the delivery units 110 are provided at a plurality of, for example, two tiers in the vertical direction as will he described later, and can delivery any two of the processing target wafer W, the supporting wafer 5, the superposed wafer T at the same time. For example, one delivery unit 110 may deliver the processing target wafer W or the supporting wafer S before joining, and the other delivery unit 110 may deliver the superposed wafer T after joining. Alternatively, one delivery unit 110 may deliver the processing target wafer W before joining, and the other delivery unit 110 may deliver the supporting wafer S before joining.

On a Y-direction negative direction side in the pre-processing region D1, namely, the transfer-in/out port 103 side, a reversing unit 111 that reverses the front and rear surfaces, for example, of the supporting wafer S is provided vertically above the delivery unit 110. Note that the reversing unit 111 can adjust the orientation in the horizontal direction of the supporting wafer S and can also adjust the orientation in the horizontal direction of the processing target wafer W as will be described later.

On a Y-direction positive direction side in the joint region D2, a transfer unit 112 that transfers the processing target wafer W, the supporting wafer S, the superposed wafer T to the delivery unit 110, the reversing unit 111, and a later-described joint unit 113 is provided. The transfer unit 112 is attached at the transfer-in/out port 103.

On a Y-direction negative direction side in the joint region D2, the joint unit 113 that presses the processing target wafer W and the supporting wafer S via the adhesive G to join them together is provided.

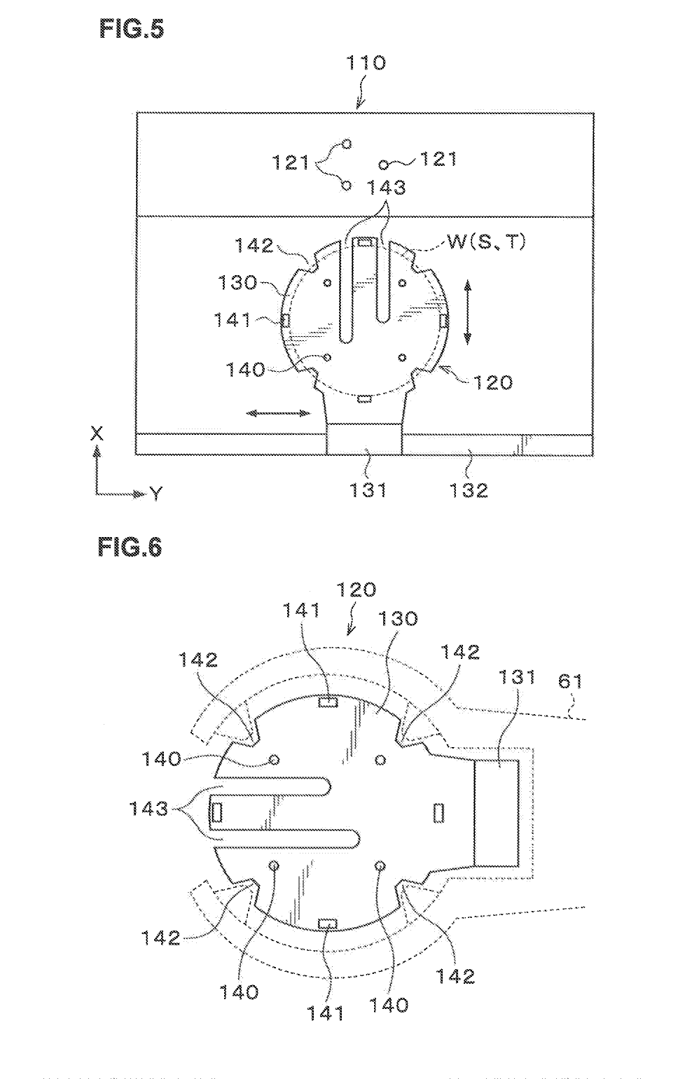

Next, the configuration of the aforementioned delivery unit 110 will be described. The delivery unit 110 has a delivery arm 120 and water support pins 121 as illustrated in FIG. 5. The delivery arm 120 can deliver the processing target wafer W, the supporting wafer S, the superposed wafer T to/from the outside of the joint apparatus 30, namely, between the wafer transfer apparatus 61 and the wafer support pins 121. The wafer support pins 121 are provided at a plurality of, for example, three positions and can support the processing target wafer W, the supporting wafer S, the superposed wafer T.

The delivery arm 120 has an arm unit 130 that holds the processing target wafer W, the supporting wafer S, the superposed wafer T and an arm drive unit 131 equipped with, for example, a motor, The arm unit 130 has an almost disk shape. The arm drive unit 131 can move the arm unit 130 in an X-direction (a top-bottom direction in FIG. 5). Further, the arm drive unit 131 is attached to a rail 132 extending in a Y-direction (a right-left direction in FIG. 5) and configured to be movable on the rail 132. With this configuration, the delivery arm 120 is movable in the horizontal direction (the X-direction. and the Y-direction), and can smoothly delivery the processing target wafer W, the supporting wafer S, the superposed wafer T between the wafer transfer apparatus 61 and the wafer support pins 121.

Further, for example, a temperature regulating member (not illustrated) such as a Peltier element is embedded in the arm unit 130. The cooling temperature of the arm unit 130 is controlled by, for example, a later-described control unit 360. Accordingly, the delivery arm 120 also has a function as a superposed substrate temperature regulation unit that regulates the superposed wafer T mounted on the delivery arm 120 to a predetermined temperature.

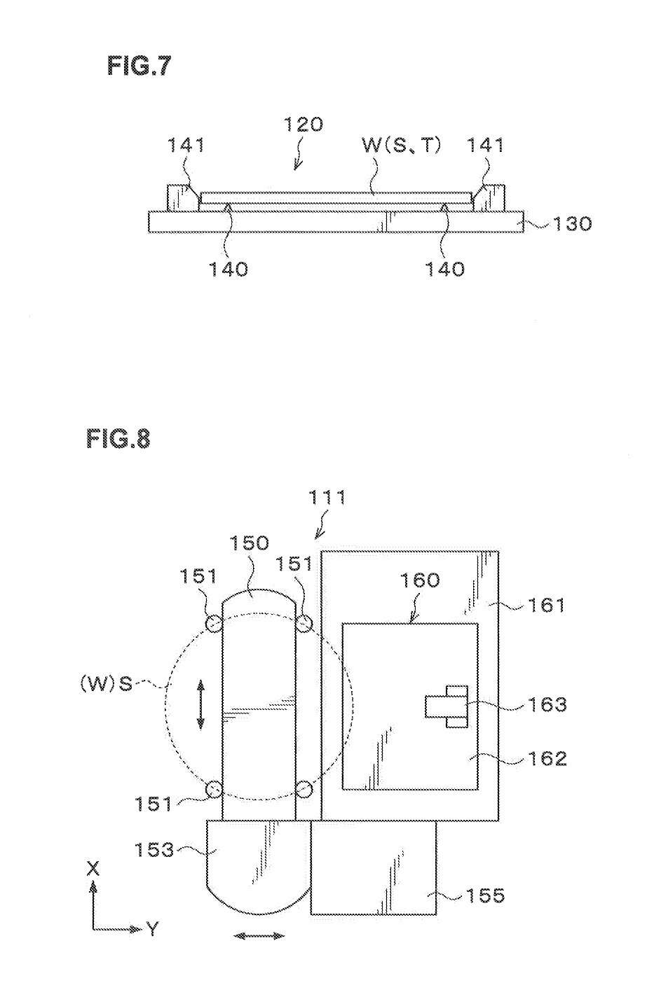

On the arm unit 130, wafer support pins 140 that support the processing target wafer W, the supporting wafer 5, the superposed wafer T are provided at a plurality of, for example, four positions as illustrated in FIG. 6 and FIG. 7. Further, guides 141 that perform positioning of the processing target wafer W, the supporting wafer S, the superposed wafer T supported on the wafer support pins 140 are provided on the arm unit 130. The guides 141 are provided at a plurality of, for example, four positions to guide the side surface of the processing target wafer W, the supporting wafer 5, the superposed wafer T.

At the outer periphery of the arm unit 130, cutouts 142 are formed, for example, at four positions as illustrated in FIG. 5 and FIG. 6. The cutouts 142 make it possible to prevent the transfer arm of the wafer transfer apparatus 61 from interfering with the arm unit 130 when the processing target wafer W, the supporting wafer S, the superposed wafer T is delivered from the transfer arm of the wafer transfer apparatus 61 to the delivery arm 120.

In the arm unit 130, two slits 143 are formed along the X direction. The slits 143 are formed from the end face on the side of the wafer support pins 121 of the arm unit 130 to the vicinity of the middle portion of the arm unit 130. The slits 143 can prevent the arm unit 130 from interfering with wafer support pins 121.

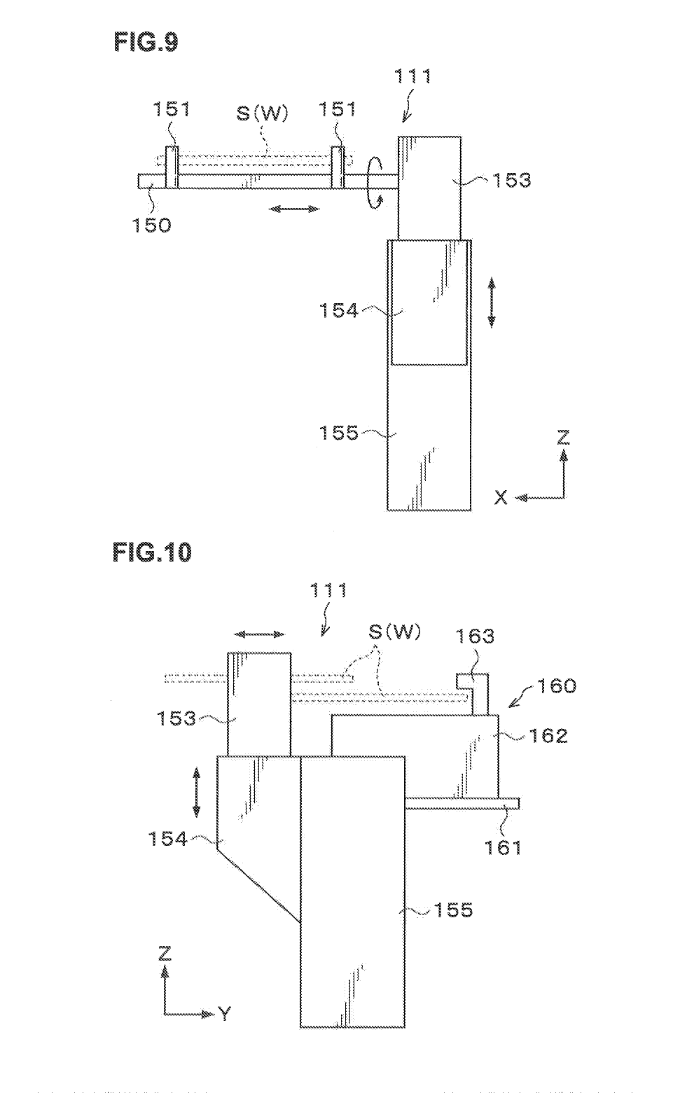

Next, the configuration of the aforementioned reversing unit 111 will be described. The reversing unit 111 has a holding aim 150 that holds the supporting wafer S, the processing target wafer W as illustrated in FIG. 8 to FIG. 10. The holding arm 150 extends in the horizontal direction (an X-direction in FIG. 8 and FIG. 9). Further, at the holding arm 150, holding members 151 that hold the supporting wafer S, the processing target wafer W are provided, for example, at four positions. The holding members 151 are configured to be movable in the horizontal direction with respect to the holding arm 150 as illustrated in FIG. 11. In the side surface of the holding member 151, a cutout 152 for holding the outer peripheral portion of the supporting wafer S, the processing target wafer W is formed. The holding members 151 can hold the supporting wafer S, the processing target wafer W sandwiched between them,

The holding arm 150 is supported by a first drive unit 153 equipped with, for example, a motor as illustrated in FIG. 8 to FIG. 10. By means of the first drive unit 153, the holding arm 150 can freely turn around a horizontal axis and move in the horizontal direction (an X-direction in FIG. 8 and FIG. 9 and a Y-direction in FIG. 8 and FIG. 10). Note that the first drive unit 153 may move the holding arm 150 in the horizontal direction by rotating the holding arm 150 around the vertical axis. Below the first drive unit 153, a second drive unit 154 equipped with, for example, a motor is provided. By means of the second drive unit 154, the first drive unit 153 can move in the vertical direction along a support post 155 extending in the vertical direction. As described above, the supporting wafer S, the processing target wafer W held by the holding members 151 can he turned around the horizontal axis and moved, in the vertical direction and the horizontal direction by the first drive unit 153 and the second drive unit 154.

A position adjusting mechanism 160 that adjusts the orientation in the horizontal direction of the supporting wafer 3, the processing target wafer

W held by the holding members 151 is supported on the support post 155 via a support plate 161. The position adjusting mechanism 160 is provided adjacent to the holding arm 150.

The position adjusting mechanism 160 has a base 162, and a detection unit 163 that detects the notch portion of the supporting wafer 3, the processing target wafer W. Then, in the position adjusting mechanism 160, the orientation in the horizontal direction of the supporting wafer 3, the processing target wafer W is adjusted by detecting the position of the notch portion of the supporting wafer 3, the processing target wafer W by the detection unit 163 while moving the supporting wafer S, the processing target wafer W held by the holding members 151 in the horizontal direction to thereby adjust the position of the notch portion.

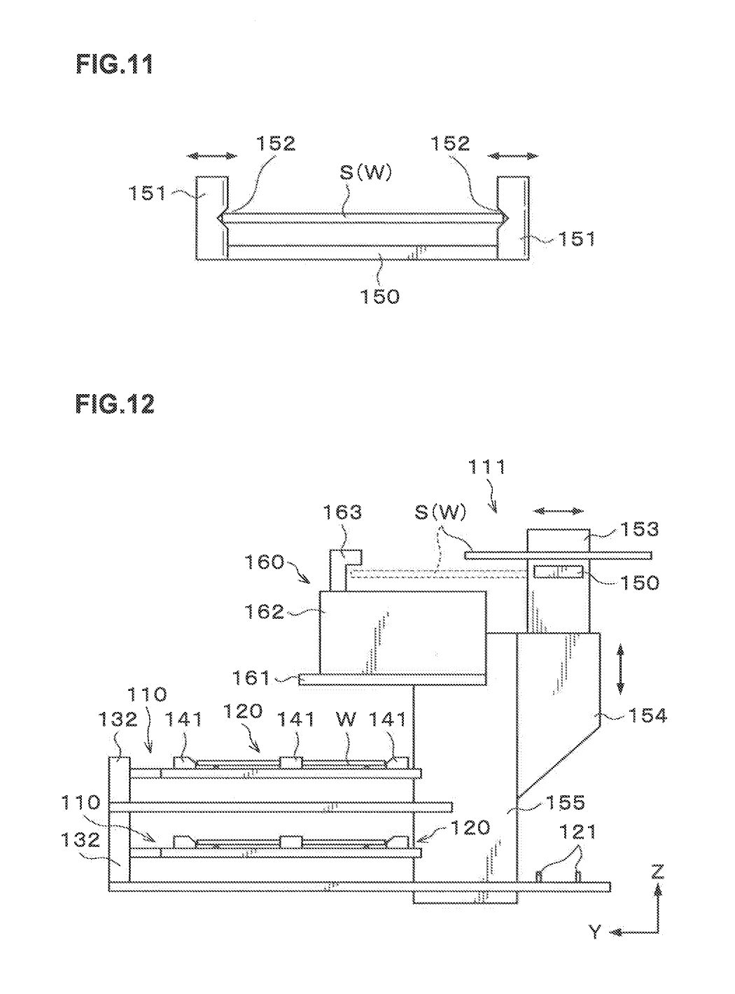

Note that delivery units 110 configured as described above are disposed at two tiers in the vertical direction as illustrated in FIG. 12, and the reversing unit 111 is disposed vertically above the delivery units 110. In other words, the delivery arms 120 of the delivery units 110 move in the horizontal direction below the holding arm 150 of the reversing unit 111 and the position adjusting mechanism 160. Further, the wafer support pins 121 of the delivery units 110 are disposed below the holding area 150 of the reversing unit 111.

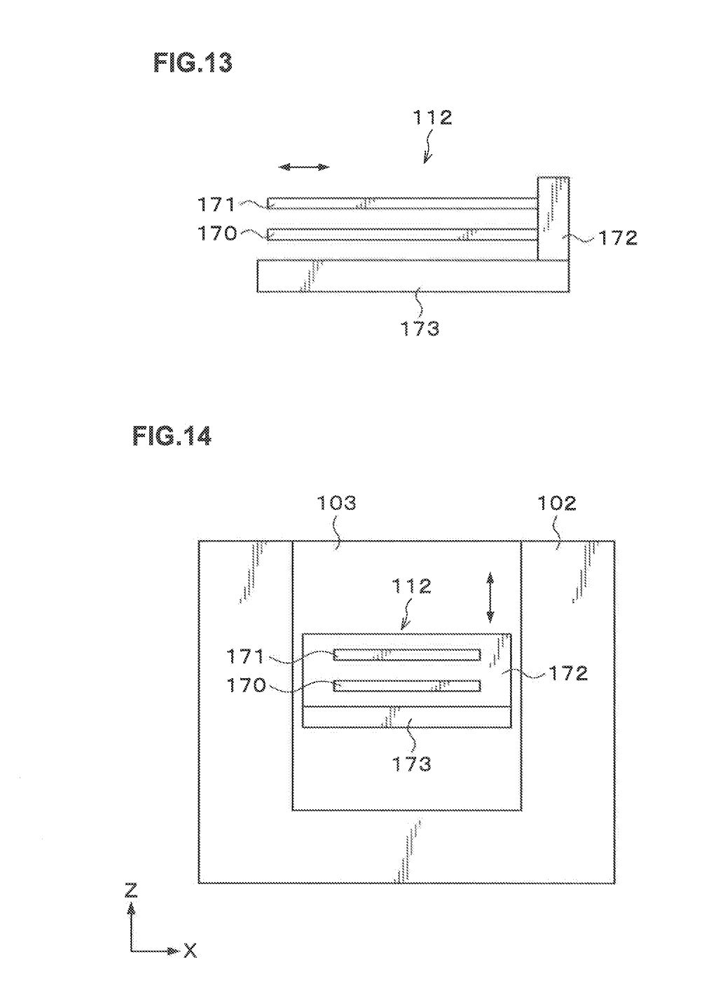

Next, the configuration of the aforementioned transfer unit 112 will be described. The transfer unit 112 has a plurality of, for example, two transfer arms 170, 171 as illustrated in FIG. 13. The first transfer arm 170 and the second transfer arm 171 are arranged at two tiers in this order from the bottom in the vertical direction. Note that the first transfer arm 170 and the second transfer am 171 have different shapes as will he described later,

At base end portions of the transfer arms 170, 171, an arm drive unit 172 equipped with, for example, a motor is provided. By means of this aim drive unit 172, each of the transfer arms 170, 171 can independently move in the horizontal direction. The transfer arms 170, 171 and the arm drive unit 172 are supported on a base 173.

The transfer unit 112 is provided at the transfer-in/out port 103 formed in the inner wall 102 of the processing container 100 as illustrated in FIG. 4 and FIG. 14. The transfer unit 112 can move in the vertical direction along the transfer-in/out port 103 by means of a drive unit (not illustrated) equipped with, for example, a motor.

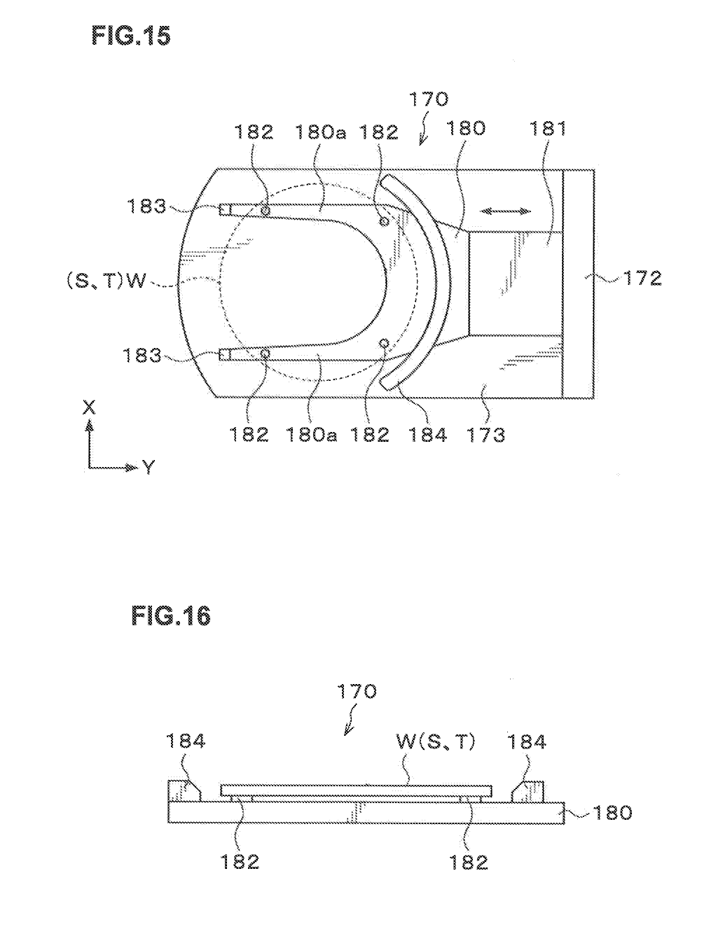

The first transfer arm 170 transfers the processing target wafer W, the supporting wafer 5, the superposed wafer T while holding the rear surface thereof (the non-joint surface W_{N}, S_{N} in the processing target wafer W, the supporting wafer S). The first transfer arm 170 has an arm unit 180 having a tip branched off into two tip end parts 180a, 180a, and a support unit 181 integrally formed with the arm unit 180 and supporting the arm unit 180 as illustrated in FIG. 15.

On the arm unit 180, O-rings 182 made of resin are provided at a plurality of, for example, four positions as illustrated in FIG. 15 and FIG. 16. The O-rings 182 hold the rear surface of the processing target wafer W, the supporting wafer 5, the superposed wafer T by the friction force when the O-rings 182 are into contact with the rear surface of the processing target wafer W, the supporting wafer 5, the superposed wafer T. This enables the first transfer arm 170 to horizontally hold the processing target wafer W, the supporting wafer 5, the superposed wafer T on the O-rings 182.

Further, guide members 183, 184 provided outside the processing target wafer W, the supporting wafer S, the superposed wafer T held on the O-rings 182 are provided on the arm unit 180. The first guide members 183 are provided at tips of the tip end parts 180a of the arm unit 180. The second guide member 184 is formed in an arc shape along the outer periphery of the processing target wafer W, the supporting wafer S, the superposed wafer T and provided on the support unit 181 side. The guide members 183, 184 can prevent the processing target wafer W, the supporting wafer S, the superposed wafer T from protruding from or slipping off the first transfer arm 170. Note that when the processing target wafer W, the supporting wafer S, the superposed wafer T is held at an appropriate position on the O-rings 182, the processing target wafer W, the supporting wafer S, the superposed wafer T never comes into contact with the guide members 183, 184.

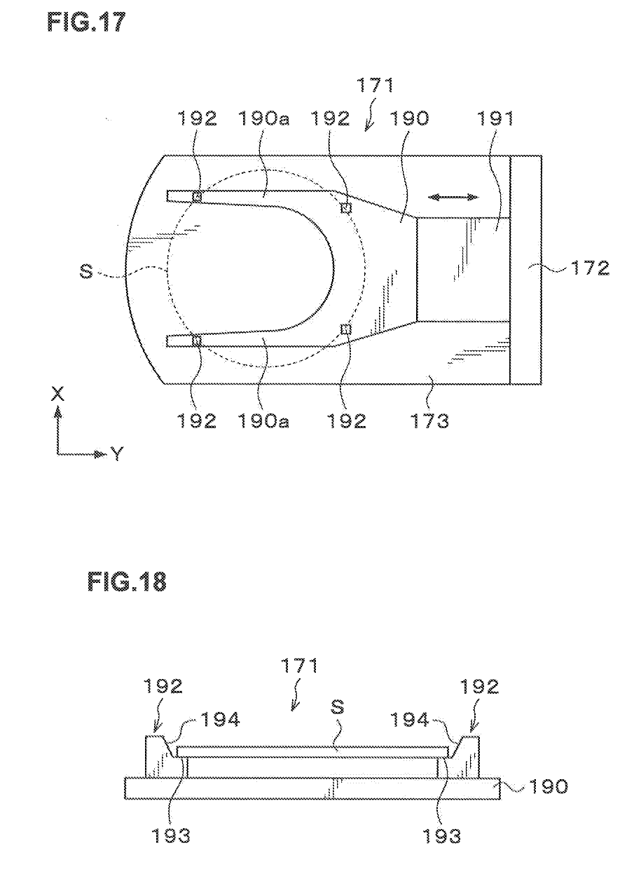

The second transfer arm 171 transfers the supporting wafer S while holding the outer peripheral portion of the front surface thereof, namely, the joint surface S_{J}, More specifically, the second transfer arm 171 transfers the supporting wafer S while holding the outer peripheral portion of the joint surface S_{J} of the supporting wafer S whose front and rear surfaces have been reversed by the reversing unit 111. The second transfer arm 171 has an arm unit 190 having a tip branched off into two tip end parts 190a, 190a, and a support unit 191 integrally formed with the arm unit 190 and supporting the arm unit 190 as illustrated in FIG. 17.

On the arm unit 190, second holding members 192 are provided at a plurality of, for example, four positions as illustrated in FIG. 17 and FIG. 18. The second holding member 192 has a mounting part 193 on which the outer peripheral portion of the joint surface S of the supporting wafer S is mounted and a tapered part 194 that extends upward from the mounting part 193 and has an inner side surface expanding in a tapered shape from the lower side to the upper side. The mounting part 193 holds the outer peripheral portion, for example, within 1 mm from the edge of the supporting wafer S. Further, since the inner side surface of the tapered part 194 expands in a tapered shape from the lower side to the upper side, the supporting wafer S can be smoothly guided by the tapered part 194 and positioned and held on the mounting part 193 even if the supporting wafer S delivered to the second holding member 192 is displaced from a predetermined position in the horizontal direction. The second transfer arm 171 can horizontally hold the supporting wafer S on the second holding members 192.

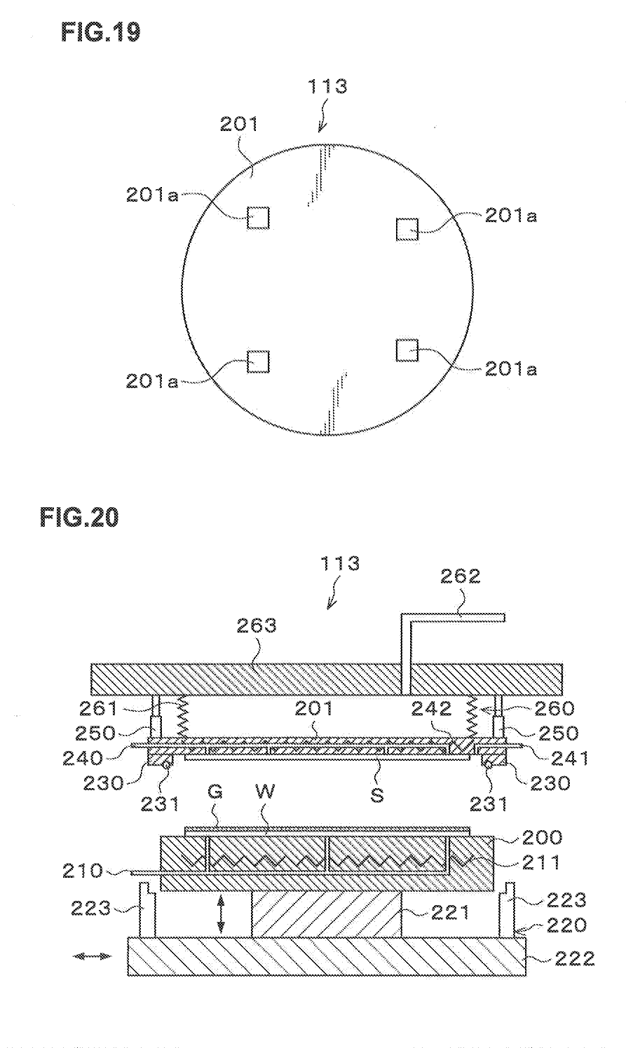

Note that cutouts 201 a are formed, for example, at four positions in a later-described second holding unit 201 of the joint unit 113 as illustrated in FIG. 19. The cutouts 201a make it possible to prevent the second holding members 192 of the second transfer arm 171 from interfering with the second holding unit 201 when the supporting wafer S is delivered from the second transfer arm 171 to the second holding unit 201.

Next, the configuration of the aforementioned joint unit 113 will be described. The joint unit 113 has a first holding unit 200 that mounts the processing target wafer W on its upper surface and the second holding unit 201 that suction-holds the supporting wafer S on its lower surface as illustrated in FIG. 20. The first holding unit 200 is provided below the second holding unit 201 and disposed to face the second holding unit 201. In other words, the processing target wafer W held on the first holding unit 200 and the supporting wafer S held on the second holding unit 201 are arranged to face each other.

inside the first holding unit 200, a suction pipe 210 for suction-holding the processing target wafer W is provided. The suction pipe 210 is connected to a negative pressure generating device (not illustrated) such as, for example, a vacuum pump. Note that for the first holding unit 200, a material having strength preventing deformation even if a load is applied thereon by a later-described. pressurizing mechanism 260, for example, ceramic such as silicon carbide ceramic, aluminum nitride ceramic or the like is used.

Further, inside the first holding unit 200, a heating mechanism 211 that heats the processing target wafer W is provided. For the heating mechanism 211, for example, a heater is used.

Below the first holding unit 200, a moving mechanism 220 that moves the first holding unit 200 and the processing target wafer W in the vertical direction and the horizontal direction is provided. The moving mechanism. 220 can three dimensionally move the first holding unit 200 with an. accuracy of for example, ±1 μm. The moving mechanism 220 has a vertical moving unit 221 that moves the first holding unit 200 in the vertical direction and a horizontal moving unit 222 that moves the first holding unit 200 in the horizontal direction. Each of the vertical moving unit 221 and the horizontal moving unit 222 has, for example, a ball screw (not illustrated) and a motor (not illustrated) that turns the ball screw.

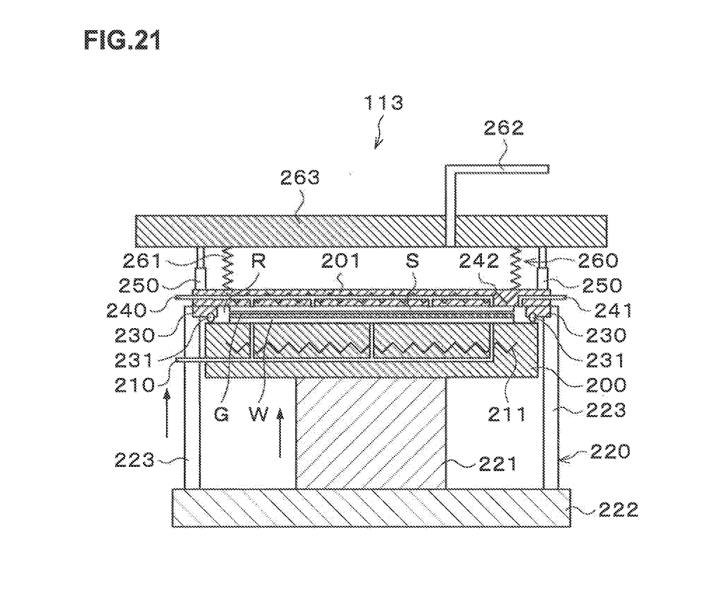

On the horizontal moving unit 222, supporting members 223 capable of extending and contracting in the vertical direction are provided, The supporting members 223 are provided, for example, at three positions outside the first holding unit 200. The supporting members 223 can support a projection part 230 provided projecting from an outer peripheral lower surface of the second holding unit 201 as illustrated in FIG. 21.

The above moving mechanism 220 can align the processing target wafer W on the first holding unit 200 in the horizontal direction, and raise the first holding unit 200 to form a joint space R for joining the processing target wafer W and the supporting wafer S together as illustrated in FIG. 21. The joint space R is a space surrounded by the first holding unit 200, the second holding unit 201 and the projection part 230. Further by adjusting the heights of the supporting members 223 when forming the joint space R, the distance in the vertical direction between the processing target wafer W and the supporting wafer S in the joint space R can be adjusted.

Note that below the first holding unit 200, raising and lowering pins (not illustrated) for supporting the processing target wafer W or the superposed wafer T from below and raising and lowering it are provided. The raising and lowering pins can pass through through holes (not illustrated) formed in the first holding unit 200 and project from the upper surface of the first holding unit 200.

For the second holding unit 201, for example, aluminum that is an elastic body is used. The second holding unit 201 is configured such that when a predetermined pressure, for example, 0.7 atmosphere 0.07 MPa) is applied on the entire surface of the second holding unit 201, a portion thereof, for example, a central portion bends as will be described later.

On the outer peripheral lower surface of the second holding unit 201, the aforementioned projection part 230 projecting downward from the outer peripheral lower surface is formed as illustrated in FIG. 20. The projection part 230 is formed along the outer periphery of the second holding unit 201. Note that the projection part 230 may be formed integrally with the second holding unit 201.

On the lower surface of the projection part 230, a sealing material 231 for keeping the air tightness of the joint space R is provided. The sealing material 231 is annually provided in a groove formed in the lower surface of the projection part 230 and, for example, an O-ring is used therefor,

Further, the sealing material 231. has elasticity. Note that the sealing material 231. only needs to he a component having a sealing function and is not limited to this embodiment.

Inside the second holding unit 201, a suction pipe 240 for suction-holding the supporting wafer S is provided. The suction pipe 240 is connected to a negative pressure generating device (not illustrated) such as, for example, a vacuum pump.

Further, inside the second holding unit 201, a suction pipe 241 for sucking the atmosphere in the joint space R is provided. One end of the suction pipe 241 is opened in the lower surface of the second holding unit 201 at a location where the supporting wafer S is not held. Further, the other end of the suction pipe 241 is connected to a negative pressure generating device (not illustrated) such as, for example, a vacuum pump.

Further, inside the second holding unit 201, a heating mechanism 242. that heats the supporting wafer S is provided, For the heating mechanism 242, for example, a heater is used.

On the upper surface of the second holding unit 201, supporting members 250 that support the second holding unit 201 and a pressurizing mechanism 260 that presses the second holding unit 201 vertically downward are provided. The pressurizing mechanism 260 has a pressure container 261 provided in a manner to cover the processing target wafer W and the supporting wafer S, and a fluid supply pipe 262 that supplies fluid, for example, compressed air into the pressure container 261. Further, the supporting members 250 are configured to be capable of extending and contracting in the vertical direction and provided, for example, at three positions outside the pressure container 261.

The pressure container 261 is composed of bellows made of, for example, stainless steel, which is capable of extending and contracting, for example, in the vertical direction. The pressure container 261 has a lower surface in abutment with the upper surface of the second holding unit 201 and an upper surface in abutment with the lower surface of a support plate 263 provided above the second holding unit 201. The fluid supply pipe 262 has one end connected to the pressure container 261 and the other end connected to a fluid supply source (not illustrated). Then, a fluid is supplied from the fluid supply pipe 262 into the pressure container 261, whereby the pressure container 261 extends. In this event, since the upper surface of the pressure container 261 is in abutment with the lower surface of the support plate 263, the pressure container 261 extends only downward to be able to press the second holding unit 201 provided on the lower surface of the pressure container 261 downward. Further, in this event, the inside of the pressure container 261 is pressurized by the fluid, so that the pressure container 261 can uniformly press the second holding unit 201. Adjustment of the load when pressing the second holding unit 201 is performed by adjusting the pressure of the compressed air to be supplied to the pressure container 261. Note that the support plate 263 is preferably composed of a member having strength avoiding deformation even if it receives the reaction force of the load applied on the second holding unit 201 by the pressurizing mechanism 260. Note that the support plate 263 of this embodiment may he omitted, and the upper surface of the pressure container 261 may be made in abutment with the ceiling surface of the processing container 100.

Note that the configurations of the joint apparatuses 31 to 33 are the same as that of the above-described joint apparatus 30, and therefore the description thereof is omitted.

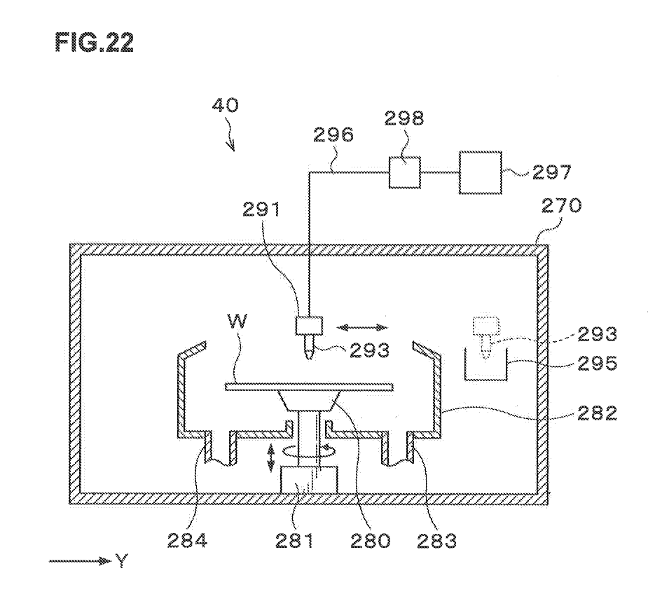

Next, the configuration of the aforementioned coating apparatus 40 will be described, The coating apparatus 40 has a treatment container 270 that can hermetically close the inside thereof as illustrated in FIG. 22. In the side surface on the wafer transfer region 60 side of the treatment container 270, a transfer-in/out port (not illustrated) for the processing target wafer W is formed, and an opening/closing shutter (not illustrated) is provided at the transfer-in/out port.

At a central. portion in the treatment container 270, a spin chuck 280 that holds and rotates the processing target wafer W thereon is provided. The spin chuck 280 has a horizontal upper surface, and a suction port (not illustrated) for sucking, for example, the processing target wafer W is provided in the upper surface. By suction through the suction port, the processing target wafer W can be suction-held on the spin chuck 280.

Below the spin chuck 280, a chuck drive unit 281 equipped with, for example, a motor and so on is provided. The spin chuck 280 can rotate at a predetermined speed by means of the chuck drive unit 281. Further, the chuck drive unit 281 is provided with a raising and lowering drive source such as, for example, a cylinder and can freely raise and lower the spin chuck 280.

Around the spin chuck 280, a cup 282 is provided which receives and recovers liquid splashing or dropping from the processing target wafer W. A drain pipe 283 that drains the recovered liquid and an exhaust pipe 284 that vacuums and exhausts the atmosphere in the cup 282 are connected to the lower surface of the cup 282.

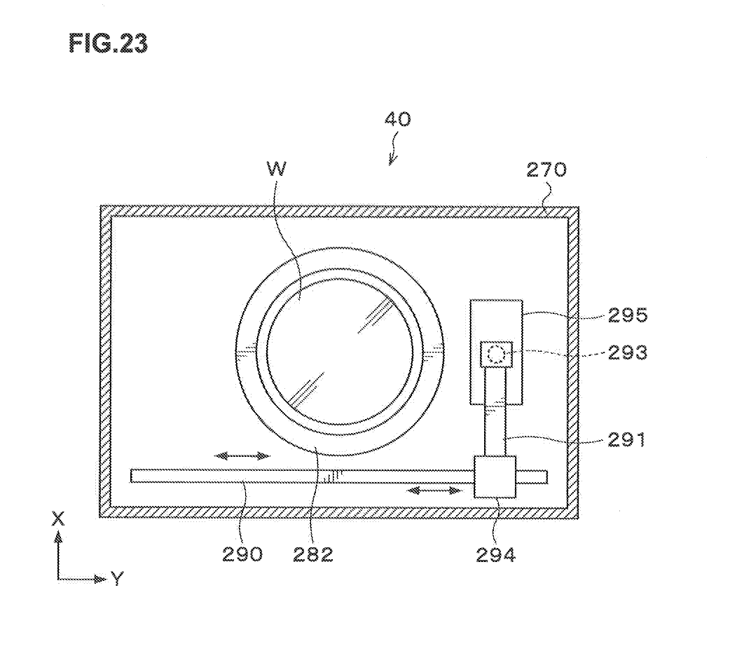

As illustrated in FIG. 23, on an X-direction negative direction (a lower direction. in FIG, 23) side of the cup 282, a rail 290 extending along a Y-direction (a right-left direction in FIG. 23) is formed. The rail 290 is formed, for example, from a Y-direction negative direction (a left direction in FIG. 23) side outer position of the cup 282 to a Y-direction positive direction (a right direction in FIG. 23) side outer position. On the rail 290, for example, an arm 291 is attached.

On the arm 291, an adhesive nozzle 293 that supplies an adhesive G in a liquid state to the processing target wafer W is supported as illustrated in FIG. 22 and FIG. 23. The arm 291 is movable on the rail 290 by means of a nozzle drive unit 294 illustrated in FIG. 23. Thus, the adhesive nozzle 293 can move from a waiting section 295 provided at the Y-direction positive direction side outer position of the cup 282 to a position above a central portion of the processing target wafer W in the cup 282, and further move in the diameter direction of the processing target wafer W above the processing target wafer W. Further, the arm 291 can freely rise and lower by means of the nozzle drive unit 294 to be able to adjust the height of the adhesive nozzle 293.

To the adhesive nozzle 293, a supply pipe 296 that supplies the adhesive G to the adhesive nozzle 293 is connected as illustrated in FIG. 22. The supply pipe 296 communicates with an adhesive supply source 297 that stores the adhesive G therein. Along the supply pipe 296, a supply equipment group 298 is further provided which includes a valve, a flow regulator and so on that control the flow of the adhesive G.

Incidentally, a back rinse nozzle (not illustrated) that jets a cleaning solution toward the rear surface of the processing target substrate W, namely, the non-joint surface W_{N} may be provided below the spin chuck 280.

The cleaning solution jetted from the back rinse nozzle cleans the non-joint surface W_{N} of the processing target wafer W and the outer peripheral portion of the processing target substrate W.

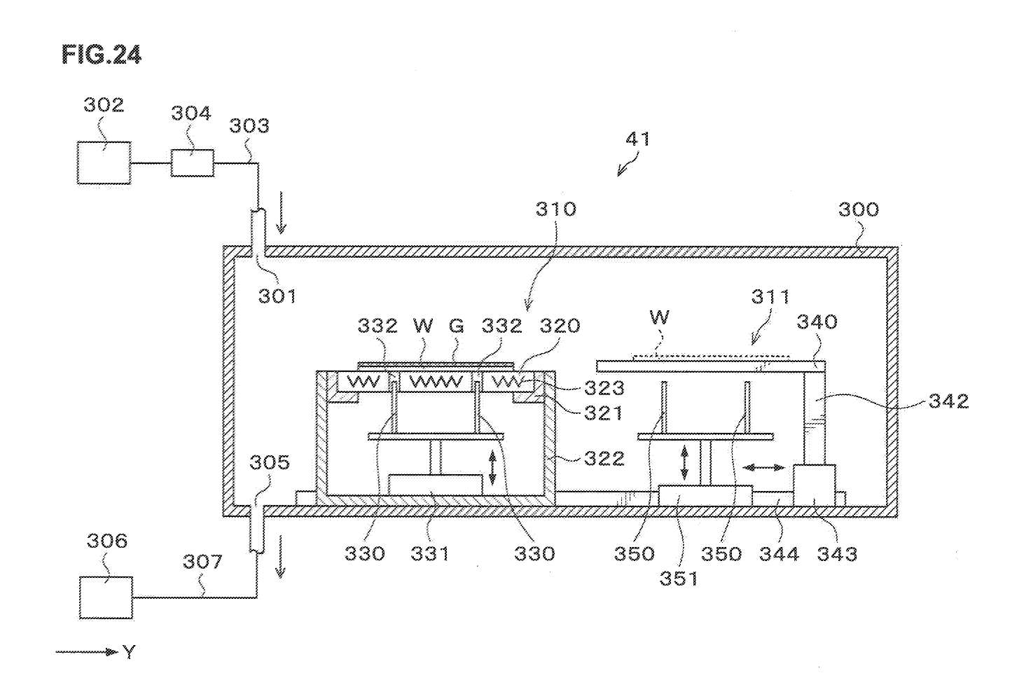

Next, the configurations of the aforementioned thermal processing apparatuses 41 to 46 will be described. The thermal processing apparatus 41 has a processing container 300 that can hermetically close the inside thereof as illustrated in FIG. 24. In the side surface on the wafer transfer region 60 side of the processing container 300, a transfer-in/out port (not illustrated) for the processing target wafer W is formed, and an opening/closing shutter (not illustrated) is provided at the transfer-in/out port.

At the ceiling surface of the processing container 300, a gas supply port 301 for supplying an inert gas such as, for example, a nitrogen gas into the processing container 300 is formed. To the gas supply port 301, a gas supply pipe 303 communicating with a gas supply source 302 is connected. Along the gas supply pipe 303, a supply equipment group 304 is provided which includes a valve, a flow regulator and so on that control the flow of the inert gas.

At the bottom surface of the processing container 300, a suction port 305 for sucking the atmosphere in the processing container 300 is formed. A suction pipe 307 communicating with a negative pressure generating device 306 such as, for example, a vacuum pump is connected to the suction port 305.

Inside the processing container 300, a heating unit 310 that performs heat processing on the processing target wafer W and a temperature regulation unit 311 that temperature regulates the processing target wafer W are provided. The heating unit 310 and the temperature regulation unit 311 are arranged side by side in the Y-direction.

The heating unit 310 includes an annular holding member 321 that accommodates a thermal plate 320 and holds the outer peripheral portion of the thermal plate 320, and a support ring 322 in an almost cylindrical shape that surrounds the outer periphery of the holding member 321. The thermal plate 320 has an almost disk shape with a large thickness and can mount and heat the processing target wafer W thereon. Further, for example, a heater 323 is embedded in the thermal plate 320. The heating temperature of the thermal plate 320 is controlled, for example, by a control unit 360 so that the processing target wafer W mounted on the thermal plate 320 is heated to a predetermined temperature.

Below the thermal plate 320, for example, three raising and lowering pins 330 for supporting the processing target wafer W from below and raising and lowering it are provided. The raising and lowering pins 330 can move up and down by means of a raising and lowering drive unit 331. Near the middle portion of the thermal plate 320, through holes 332 penetrating the thermal plate 320 in the thickness direction are formed, for example, at three positions. Then, the raising and lowering pins 330 can pass through the through holes 332 and project from the upper surface of the thermal plate 320.

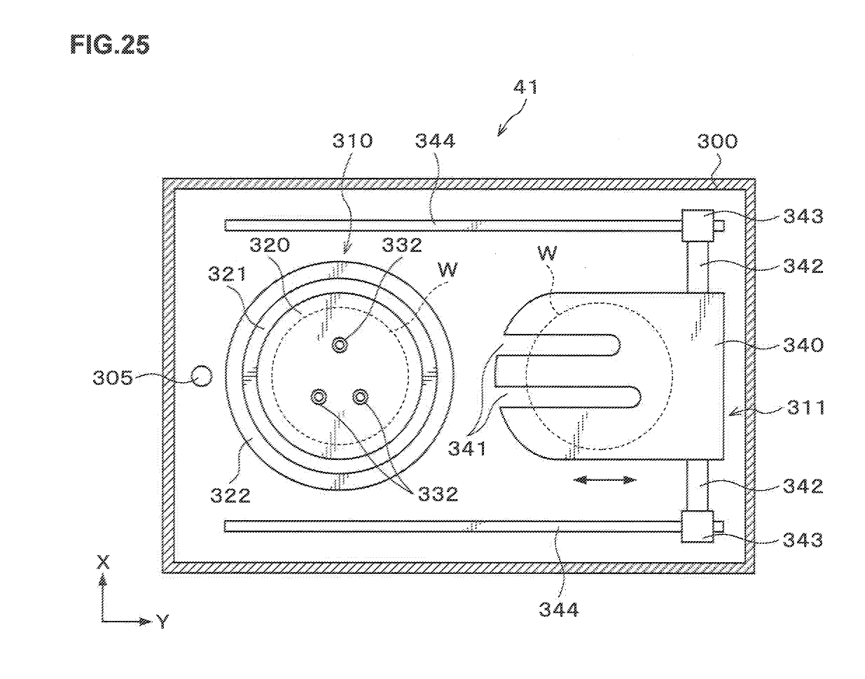

The temperature regulation unit 311 has a temperature regulation plate 340. The temperature regulation plate 340 has an almost square flat plate shape as illustrated in FIG. 25 and has an end face on the thermal plate 320 side curved in an arc shape. In the temperature regulation plate 340, two slits 341 are formed along the Y-direction. The slits 341 are formed from the end face on the thermal plate 320 side of the temperature regulation plate 340 to the vicinity of the middle portion of the temperature regulation plate 340. The slits 341 can prevent the temperature regulation plate 340 from interfering with the raising and lowering pins 330 of the heating unit 310 and later-described raising and lowering pins 350 of the temperature regulation unit 311. Further, a temperature regulation member (not illustrated) such as a Peltier element is embedded in the temperature regulation plate 340. The cooling temperature of the temperature regulation plate 340 is controlled, for example, by the control unit 360 so that the processing target wafer W mounted on the temperature regulation plate 340 is cooled to a predetermined temperature.

The temperature regulation plate 340 is supported on a support arm 342 as illustrated in FIG. 24. To the support arm 342, a drive unit 343 is attached. The drive unit 343 is attached on a rail 344 extending in the Y-direction, The rail 344 extends from the temperature regulation unit 311 to the heating unit 310. By means of the drive unit 343, the temperature regulation plate 340 can move along the rail 344 between the heating unit 310 and the temperature regulation unit 311.

Below the temperature regulation plate 340, for example, three raising and lowering pins 350 for supporting the processing target wafer W from below and raising and lowering it are provided. The raising and lowering pins 350 can more up and down by means of a raising and lowering drive unit 351. Then, the raising and lowering pins 350 can pass through the slits 341 and project from the upper surface of the temperature regulation plate 340.

Note that the configurations of the thermal processing apparatuses 42 to 46 are the same as that of the above-described thermal processing apparatus 41, and therefore the description thereof is omitted.

In the above joint system 1, the control unit 360 is provided as illustrated in FIG. 1. The control unit 360 is, for example, a computer and has a program storage unit (not illustrated). In the program storage unit, a program is stored which controls the processing on the processing target wafer W, the supporting wafer S, the superposed wafer T in the joint system 1. Further, the program storage unit also stores a program that controls the operation of the driving system such as the above-described various processing and treatment apparatuses and transfer apparatuses to implement later-described joint processing in the joint system 1, Note that the program may be the one that is stored, for example, in a computer-readable storage medium H such as a computer-readable hard disk (HD), flexible disk (FD), compact disk: (CD), magneto-optical disk (MO), or memory card, and installed from the storage medium H into the control unit 360.

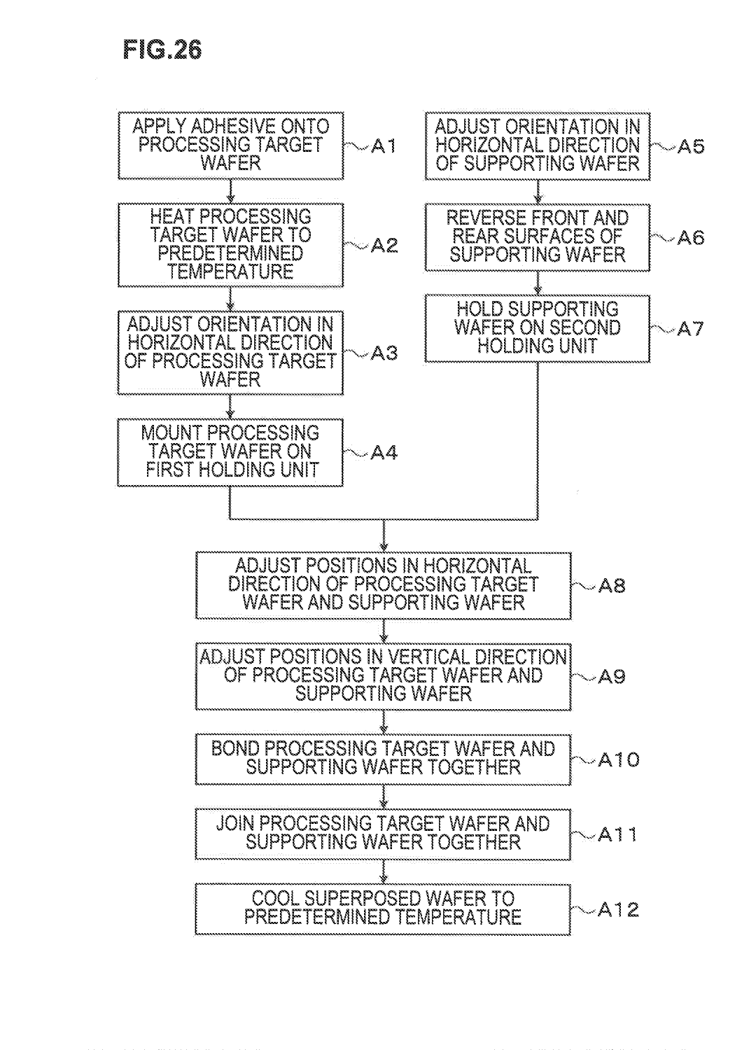

Next, the joint processing method of the processing target wafer W and the supporting wafer S performed using the joint system I configured as described above will be described. FIG. 26 is a flowchart illustrating an example of main steps of the joint processing.

First, a cassette C_{W} housing a plurality of processing target wafers W, a cassette C_{S} housing a plurality of supporting wafers S, and an empty cassette C_{T} are mounted on predetermined cassette mounting plates 11 in the transfer-in/out station 2. Then, a processing target wafer W in the cassette C_{W} is taken out by the wafer transfer apparatus 22 and transferred to the transition apparatus 50 in the third processing block G3 of the processing station 3. In this event, the processing target wafer W is transferred with the non joint surface W_{N} facing downward.

Subsequently, the processing target wafer W is transferred by the wafer transfer apparatus 61 to the coating apparatus 40. The processing target wafer W transferred in the coating apparatus 40 is delivered from the wafer transfer apparatus 61 to the spin chuck 280 and suction-held thereon. In this event, the non-joint surface W_{N} of the processing target wafer W is suction-held.

Subsequently, the arm 291 moves the adhesive nozzle 293 at the waiting section 295 to a position above a central portion of the processing target wafer W. Thereafter, while the processing target wafer W is being rotated by the spin chuck 280, the adhesive G is supplied from the adhesive nozzle 293 to the joint surface W_{J} of the processing target wafer W. The supplied adhesive G is diffused over the entire joint surface W_{J} of the processing target wafer W by the centrifugal force, whereby the adhesive G is applied over the joint surface W_{J} of the processing target wafer W (Step A1 in FIG. 26).

Subsequently, the processing target wafer W is transferred by the wafer transfer apparatus 61 to the thermal processing apparatus 41. In this event, the atmosphere of the inert gas is maintained inside the thermal processing apparatus 41. After the processing target wafer W transferred into the thermal processing apparatus 41, the processing target wafer W is delivered from the wafer transfer apparatus 61 to the raising and lowering pins 350 which have been raised and waiting in advance. Subsequently, the raising and lowering pins 350 are lowered to mount the processing target wafer W on the temperature regulation plate 340.

Thereafter, the temperature regulation plate 340 is moved by the drive unit 343 to above the thermal plate 320 along the rail 344, and the processing target wafer W is delivered to the raising and lowering pins 330 which have been raised and waiting in advance. Thereafter, the raising and lowering pins 330 are lowered to mount the processing target wafer W on the thermal plate 320. Then, the processing target wafer W on the thermal plate 320 is heated to a predetermined temperature, for example, 100° C. to 300° C. (Step A2 in FIG. 26). The heating performed by the thermal plate 320 heats the adhesive G on the processing target wafer W so that the adhesive U hardens.

Thereafter, the raising and lowering pins 330 are raised and the temperature regulation plate 340 is moved to above the thermal plate 320. Subsequently, the processing target wafer W is delivered from the raising and lowering pins 330 to the temperature regulation plate 340, and the temperature regulation plate 340 is moved to the wafer transfer region 60 side. During the movement of the temperature regulation plate 340, the processing target wafer W is temperature-regulated to a predetermined temperature.

The processing target wafer W which has been subjected to thermal processing in the thermal processing apparatus 41 is transferred by the wafer transfer apparatus 61 to the joint apparatus 30. The processing target wafer W transferred to the joint apparatus 30 is delivered from the wafer transfer apparatus 61 to the delivery arm 120 of the delivery unit 110, and then further delivered from the delivery arm 120 to the wafer support pins 121. Then, the processing target wafer W is transferred by the first transfer arm 170 of the transfer unit 112 from the wafer support pins 121 to the reversing unit 111.

The processing target wafer W transferred to the reversing unit 111 is held by the holding members 151 and moved to the position adjusting mechanism 160. Then, in the position adjusting mechanism 160, the position of the notch portion of the processing target wafer W is adjusted, whereby the orientation in the horizontal direction of the processing target wafer W is adjusted (Step A3 in FIG. 26).

Thereafter, the processing target water W is transferred by the first transfer arm 170 of the transfer unit 112 from the reversing unit 111 to the joint unit 113. The processing target wafer W transferred to the joint unit 113 is mounted on the first holding unit 200 (Step A4 in FIG. 26). On the first holding unit 200, the processing target wafer W is mounted with the joint surface W_{J} of the processing target wafer W facing upward, namely, the adhesive facing upward.

During the time when the above-described processing at Steps A1. to A4 is performed on the processing target wafer W, the supporting wafer S is subjected to processing subsequently to the processing target wafer W. The supporting wafer S is transferred by the wafer transfer apparatus 61 to the joint apparatus 30. Note that the step of transferring the supporting wafer S to the joint apparatus 30 is the same as that in the above embodiment, and therefore the description thereof is omitted.

The supporting wafer S transferred to the joint apparatus 30 is delivered from the wafer transfer apparatus 61 to the delivery arm 120 of the delivery unit 110, and then delivered from the delivery arm 120 to the wafer supporting pins 121. Thereafter, the supporting wafer S is transferred by the first transfer arm 170 of the transfer unit 112 from the wafer supporting pins 121 to the reversing unit 111. Further, after the supporting wafer S is transferred from the delivery arm 120 to the water supporting pins 121, the arm unit 130 of the delivery arm 120 is temperature-regulated by the embedded temperature regulating member to a predetermined processing temperature, for example, room temperature (23° C.).

The supporting wafer S transferred to the reversing unit 111 is held by the holding members 151 and moved to the position adjusting mechanism 160. Then, in the position adjusting mechanism 160, the position of the notch portion of the supporting wafer S is adjusted, whereby the orientation in the horizontal direction of the supporting wafer S is adjusted (Step A5 in FIG, 26). The supporting wafer S whose orientation in the horizontal direction has been adjusted is moved in the horizontal direction from the position adjusting mechanism 160 and moved upward in the vertical direction, and then the front and rear surfaces thereof ate reversed (Step A6 in FIG. 26). In short, the joint surface S_{J} of the supporting wafer S is directed downward.

Thereafter, the supporting wafer S is moved downward in the vertical direction and then transferred by the second transfer arm 171 of the transfer unit 112 from the reversing unit 111 to the joint unit 113. In this event, the second transfer arm 171 holds only the outer peripheral portion of the joint surface S_{J} of the supporting wafer S, so that the joint surface S_{J} is never contaminated with, for example, particles adhering to the second transfer arm 171. The supporting wafer S transferred to the joint unit 113 is suction-held on the second holding unit 201 (Step A7 in FIG, 26). At the second holding unit 201, the supporting wafer S is held with the joint surface S_{J} of the supporting wafer S facing downward.

In the joint apparatus 30, after the processing target wafer W and the supporting wafer S are held on the first holding unit 200 and the second holding unit 201 respectively, the position in the horizontal direction. of the first holding unit 200 is adjusted by the moving mechanism 220 so that the processing target wafer W faces the supporting wafer S (Step A8 in FIG. 26). Note that in. this event, the pressure between the second holding unit 201 and the supporting wafer S is, for example, 0.1 atmosphere (=0.01 MPa). Further, the pressure applied on the upper surface of the second holding unit 201 is 1.0 atmosphere (=0.1 MPa) that is the atmospheric pressure. To maintain the atmospheric pressure applied on the upper surface of the second holding unit 201, the pressure in the pressure container 261 of the pressurizing mechanism 260 may be the atmospheric pressure, or a gap may be formed between the upper surface of the second holding unit 201 and the pressure container 261.

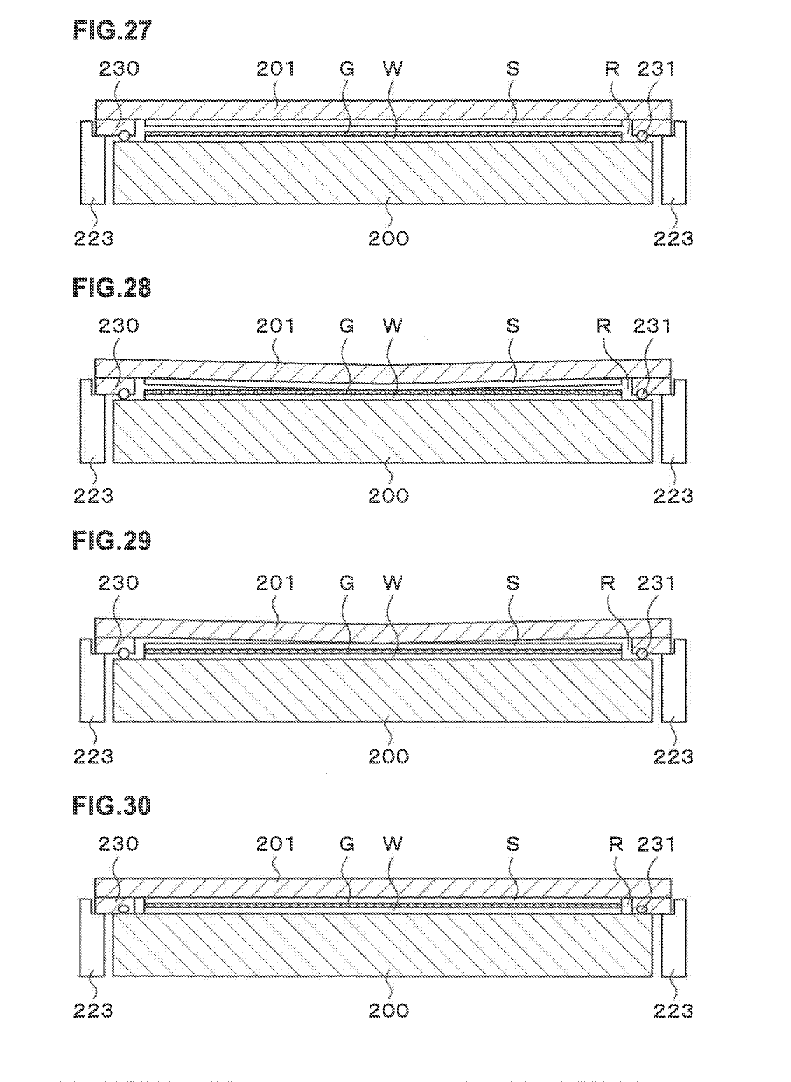

Then, as illustrated in FIG. 27, the first holding unit 200 is raised by the moving mechanism 220 and the supporting members 223 are extended, whereby the second holding unit 201 is supported by the supporting members 223. In this event, by adjusting the heights of the supporting members 223, the distance in the vertical direction between the processing target wafer W and the supporting wafer S is adjusted to be a predetermined distance (Step A9 in FIG. 26). Note that this predetermined distance is the height ensuring that the central portion of the supporting wafer S comes into contact with the processing target wafer W when the sealing material 231 comes into contact with the first holding unit 200 and the central portions of the second holding unit 201 and the supporting wafer S bend as will be described later. In this manner, the sealed joint space R is formed between the first holding unit 200 and the second holding unit 201.

Thereafter, the atmosphere in the joint space R is sucked from the suction pipe 241. Then, once the pressure in the joint space R is reduced, for example, to 0.3 atmosphere (=0.03 MPa), the pressure difference between the pressure applied on the upper surface of the second holding unit 201 and the pressure in the joint space R, namely, 0.7 atmosphere (=0.07 MPa) is applied on the second holding unit 201. Then, the central portion of the second holding unit 201 bends as illustrated in FIG. 28, and the central portion of the supporting wafer S held on the second holding unit 201 also bends. Note that since the pressure between the second holding unit 201 and the supporting wafer S is 0.1 atmosphere (=0.01 MPa) even when the pressure in the joint space R is reduced down to 0.3 atmosphere (=0.03 MPa), the supporting wafer S is kept held on the second holding unit 201.

Thereafter, the atmosphere in the joint space R is sucked to reduce the pressure in the joint space R. Then, when the pressure in the joint space R becomes 0.1 atmosphere (=0.01 MPa) or lower, the second holding unit 201 cannot hold the supporting wafer S any longer, so that the supporting wafer S falls down as illustrated in FIG. 29 and the entire joint surface S_{J} of the supporting wafer S comes into abutment with the entire joint surface W_{J} of the processing target wafer W. In this event, the supporting wafer S comes into abutment with the processing target wafer W in sequence from the abutted central portion toward the outside in the diameter direction. In other words, even when air that can be a void exists in the joint space R, the air exists at all times outside the position where the supporting wafer S is in abutment with the processing target wafer W, so that the air can escape from between the processing target wafer W and the supporting wafer S. In this manner, the processing target wafer W and the supporting wafer S are bonded together with the adhesive G while suppressing the occurrence of a void (Step A10 in FIG. 26).

Thereafter, as illustrated in FIG. 30, the heights of the supporting members 223 are adjusted to bring the lower surface of the second holding unit 201 into contact with the non-joint surface S_{N} of the supporting wafer S. In this event, the sealing material 231 elastically deforms to bring the first holding unit 200 and the second holding unit 201 into close contact. Then, while the heating mechanisms 211, 242 are heating the processing target wafer W and the supporting wafer S to a predetermined temperature, for example, 200° C., the pressurizing mechanism 260 presses the second holding unit 201 downward at a predetermined pressure, for example, 0.5 MPa. Then, the processing target wafer W and the supporting wafer S are more tightly bonded and joined together (Step A11 in FIG. 26).

The superposed wafer T in which the processing target wafer W and the supporting wafer S are joined together is transferred by the first transfer arm 170 of the transfer unit 112 from the joint unit 113 to the delivery unit 110. The superposed wafer T transferred to the delivery unit 110 is delivered via the wafer support pins 121 to the delivery arm 120 which has been temperature-regulated to room temperature in advance. In this event, the superposed wafer T is held on the delivery arm 120 for a predetermined period and cooled down to room temperature (Step A12 in FIG. 26). Then, the superposed wafer T is delivered from the delivery arm 120 to the wafer transfer apparatus 61. Note that in the temperature regulation of the superposed wafer T by the delivery arm 120, the superposed wafer T does not always need to be cooled down to room temperature but to a temperature causing no warpage or distortion during the transfer of the superposed wafer T, for example, 50° C. or lower.

Then, the superposed wafer T is transferred by the wafer transfer apparatus 61 to the transition apparatus 51 and then transfer red by the wafer transfer apparatus 22 in the transfer-in/out station 2 to the cassette C_{T} on the predetermined cassette mounting plate 11. Thus, a series of joint processing on the processing target wafer W and the supporting wafer S ends.

According to the above embodiment, the joint unit 113 and the delivery arm 120 as a superposed substrate temperature regulation unit that temperature-regulates the superposed wafer T joined in the joint unit 113 are provided in the processing container 100 of the joint apparatus 30, so that the superposed wafer T joined in the joint unit 113 can be cooled down to the temperature causing no warpage or distortion before it is transferred by the external wafer transfer apparatus 61 outside the processing container 100.

This can suppress occurrence of warpage or distortion in the processing target wafer W joined with the supporting wafer S, during the transfer of the superposed wafer T by the wafer transfer apparatus 61.

Further, the delivery arm 120 functions as the temperature regulation unit and therefore can temperature-regulate the superposed wafer

T in the process of a series of operation of delivering the superposed wafer T to the wafer transfer apparatus 61 outside the joint apparatus 30. Therefore, the period required for the temperature regulation of the superposed wafer T can be minimized.

Further, when the above-described bonding apparatus of Patent Document 1 is used, the front and rear surfaces of the wafer need to be reversed outside the bonding apparatus. In this case, since the wafer needs to be transferred to the bonding apparatus after the front and rear surfaces of the wafer are reversed, there is room to improve the throughput of the whole joint processing. Further, when the front and rear surfaces of the wafer are reversed, the joint surface of the wafer faces downward. In this case, when using an ordinary transfer apparatus that holds the rear surface of the wafer, the joint surface of the wafer will be held on the transfer apparatus, so that, for example, if particles and so on adhere to the transfer apparatus, the particles possibly adhere to the joint surface of the wafer. Further, the bonding apparatus of Patent Document 1 does not include the function of adjusting the orientations in the horizontal direction of the wafer and the supporting substrate, so that the wafer and the supporting substrate are possibly joined together displaced from each other.

In this regard, according to this embodiment, since both the reversing unit 111 and the joint unit 113 are provided in the joint apparatus 30, the supporting wafer S can be transferred by the transfer unit 112 to the joint unit 113 immediately after the supporting wafer S is reversed. Since both the reversal of the supporting wafer S and the joining of the processing target wafer W and the supporting wafer S are performed in one joint apparatus 30 as described above, the joining of the processing target wafer W and the supporting wafer S can be efficiently performed. Accordingly, the throughput of the joint processing can further be improved.

Further, since the second transfer arm 171 of the transfer unit 112 holds the outer peripheral portion of the joint surface S_{J} of the supporting wafer S, the joint surface S_{J} is never contaminated with, for example, the particles and the like adhering to the second transfer arm 171. Further, the first transfer arm 170 of the transfer unit 112 transfers the processing target wafer W, the supporting wafer S, the superposed wafer T while holding the non joint surface W_{N}, the joint surface S_{J}, the rear surface, respectively. The transfer unit 112 includes two kinds of transfer arms 170, 171 as described above and therefore can efficiently transfer the processing target wafer W, the supporting wafer S, the superposed wafer T.

Further, since the inner side surface of the tapered part 194 of the second holding member 192 expands in a tapered shape from the lower side to the upper side in the second transfer arm 171, the tapered parts 194 can smoothly guide the supporting wafer S and position it, for example, even if the supporting wafer S to be delivered to the second holding member 192 is displaced from a predetermined position in the horizontal direction.

Further, the guide members 183, 184 are provided on the arm unit 180 in the first transfer arm 170 and therefore can prevent the processing target wafer, W, the supporting wafer S, the superposed wafer T from protruding from or slipping off the first transfer arm 170.

Further, the reversing unit 111 can reverse the front and rear surfaces of the supporting wafer S by the first drive unit 153 and adjust the orientations in the horizontal direction of the supporting wafer S and the processing target wafer W by the position adjusting mechanism 160.

Accordingly, the supporting wafer S and the processing target wafer W can be appropriately joined together in the joint unit 113. Further, since the reversal of the supporting wafer S and the adjustment of the orientations in the horizontal direction of the supporting wafer S and the processing target wafer W are performed in one reversing unit 111 in the joint unit 113, the joining of the processing target wafer W and the supporting wafer S can be efficiently performed. Accordingly, the throughput of the joint processing can further be improved.

Further, the delivery units 110 are arranged at two tiers in the vertical direction and therefore can delivery any two of the processing target wafer W, the supporting wafer S, the superposed wafer T at the same time. Accordingly, the processing target wafer W, the supporting wafer S, the superposed wafer T can be efficiently delivered to/from the outside of the joint apparatus 30, and the throughput of the joint processing can further be improved.

Further, since an inert gas atmosphere can be maintained inside the thermal processing apparatus 41, it is possible to suppress formation of an oxide film on the processing target wafer W. Therefore, the thermal processing of the processing target wafer W can be appropriately performed.

Note that though the processing target wafer W and the supporting wafer S are joined together with the processing target wafer W arranged on the lower side and the supporting wafer S arranged on the upper side in the above embodiment, the vertical arrangement of the processing target wafer W and the supporting wafer S may be reversed. In this case, the above-described Steps A1 to A4 are performed on the supporting wafer S and the adhesive G is applied on the joint surface S_{J} of the supporting wafer S.

Further, the above-described Steps A5 to A7 are performed on the processing target wafer W and the front and rear surfaces of the processing target wafer W are reversed. Then, the above-described Steps A8 to A12 are performed to join the supporting wafer S and the processing target wafer W together. However, it is preferable to apply the adhesive G on the processing target wafer W from the viewpoint of protecting the electronic circuits and the like on the processing target wafer W.

Further, though the adhesive G is applied on one of the processing target wafer W and the supporting wafer S in the coating apparatus 40 in the above embodiment, the adhesive G may be applied on both of the processing target wafer W and the supporting wafer S.

Though the processing target wafer W is heated to a predetermined temperature of 100° C. to 300° C. at Step A2 in the above embodiment, the thermal processing on the processing target wafer W may be performed at two stages. For example, the processing target wafer W is heated to a first thermal processing temperature, for example, 100° C. to 150° C. in the thermal processing apparatus 41, and then heated to a second thermal processing temperature, for example, 150° C. to 300° C. in the thermal processing apparatus 44. In this case, the temperatures of the heating mechanisms themselves in the thermal processing apparatus 41 and the thermal processing apparatus 44 can be fixed. Accordingly, it is unnecessary to temperature-regulate the heating mechanisms so as to further improve the throughput of the joint processing on the processing target wafer W and the supporting wafer S.

Though the temperature regulation of the superposed wafer T is performed by the delivery arm 120 in the above embodiment, the temperature regulation of the superposed wafer T does not always needs to be performed by the delivery arm 120 but may be performed, for example, by the transfer arm 170 if it is performed before the superposed wafer T is transferred out of the processing container 100, in other words, before the superposed wafer T is delivered to the wafer transfer apparatus 61 outside the joint apparatus 30.

In this case, as the transfer arm 170, the one including an arm unit in an almost disk shape having an embedded temperature regulation member such as an internal Peltier element as with the delivery arm 120 is used. Note that in this case, the cutouts 201a in the second holding unit 201 of the joint unit 113 are formed to correspond to the positions and sizes of the guides 141 of the delivery arm 120.

The temperature regulation performed on the superposed wafer T using the transfer arm 170 with the same configuration as that of the delivery arm 120 makes it possible to further suppress the occurrence of warpage or distortion in the processing target wafer W joined with the supporting wafer S. More specifically, when the superposed wafer T before temperature regulation is delivered to the wafer support pins 121 of the delivery unit 110, the superposed wafer T is supported on the wafer support pins 121 as it is kept at a high temperature, and therefore warpage or distortion may occur it the superposed wafer T during the time when it is supported on the wafer support pins 121. In this regard, the temperature regulation performed on the superposed wafer T by the transfer arm 170 in an almost disk shape eliminates warpage or distortion of the superposed wafer T due to the wafer support pins 121.

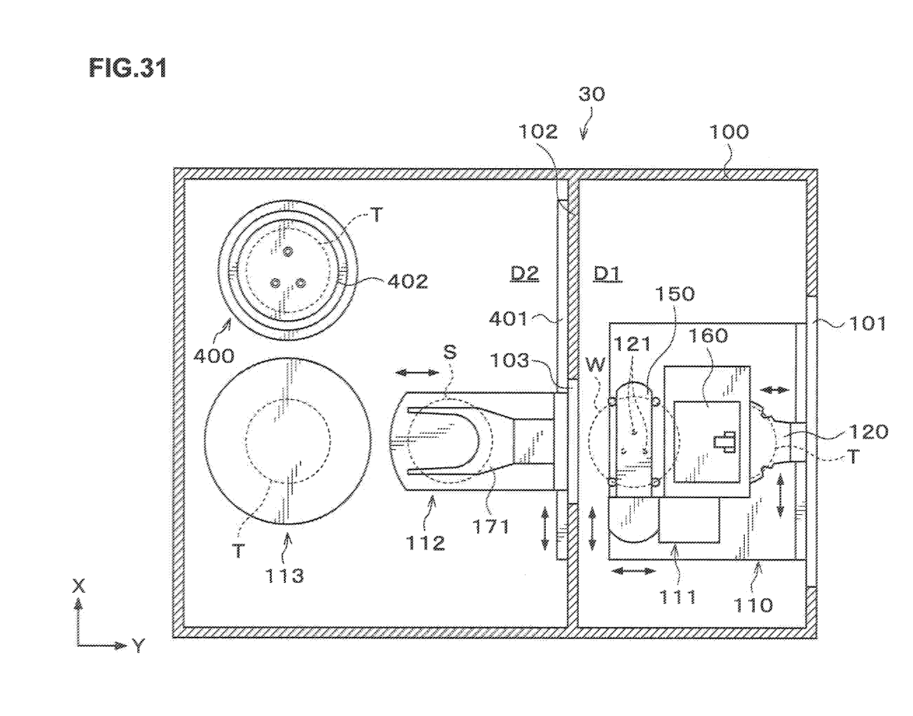

Further, for the temperature regulation of the superposed wafer T by other than the delivery arm 120 or the transfer arm 170, for example, a superposed wafer temperature regulation unit 400 as a superposed substrate temperature regulation unit may be separately provided in the joint region D2 in the joint apparatus 30 as illustrated in FIG. 31 so that the temperature regulation of the superposed wafer T is performed by the superposed wafer temperature regulation unit 400.

In this case, the transfer unit 112 is movably provided on a rail 401 extending in an X-direction as illustrated in FIG. 31. The superposed wafer T joined in the joint unit 113 is transferred by the transfer arm 170 to the superposed wafer temperature regulation unit 400 disposed on an X-direction positive direction side. Then, the superposed wafer T is cooled down to room temperature at the superposed wafer temperature regulation unit 400 and delivered to the wafer transfer apparatus 61. via the wafer support pins 121 and the delivery arm 120. Note that the superposed wafer temperature regulation unit 400 has the same configuration as that of, for example, the thermal processing apparatus 41, in which a temperature-regulation plate 402 having a temperature regulation member such as a Peltier element replacing the heater 323 embedded in the heating unit 310 is used in place of the thermal plate 320.

Preferred embodiments of the present invention have been described above with reference to the accompanying drawings, but the present invention is not limited to the embodiments. It should be understood that various changes and modifications are readily apparent to those skilled in the art within the scope of the technical spirit as set forth in claims, and those should also be covered by the technical scope of the present invention, The present invention is not limited to the embodiments but may take various forms. The present invention is also applicable to the ease where the processing target substrate is a substrate other than the wafer, such as an FPD (Flat Panel Display), a mask reticle for a photomask or the like. The present invention is also applicable to the case where the supporting substrate is a substrate other than the wafer, such as a glass substrate or the like.

What is claimed is:

1. A joint apparatus that joins a. processing target substrate and a supporting substrate together, comprising:
a processing container that is capable of hermetically closing an inside thereof;
a joint unit that joins the processing target substrate and the supporting substrate together by pressing the processing target substrate and the supporting substrate via an adhesive; and
a superposed substrate temperature regulation unit that temperature-regulates a superposed substrate joined in the joint unit,
wherein the joint unit and the superposed substrate temperature regulation unit are arranged in the processing container.

2. The joint apparatus according to claim 1, further comprising:
a delivery unit, provided in the processing container, for delivering the processing target substrate, the supporting substrate, or the superposed substrate to/from an outside of the processing container,
wherein the superposed substrate temperature regulation unit is provided in the delivery unit.

3. The joint apparatus according to claim 2,
wherein the delivery unit includes a delivery arm in an almost disk shape, and
wherein the superposed substrate temperature regulation unit is the delivery arm in which a temperature regulation member is embedded.

4. The joint apparatus according to claim 2, further comprising:
in the processing container,
a reversing unit that reverses front and rear surfaces of the supporting substrate to be joined with the processing target substrate to which the adhesive has been applied and which has been heated to a predetermined temperature or the processing target substrate to be joined with the supporting substrate to which the adhesive has been applied and which has been heated to a predetermined temperature; and
a transfer unit that transfers the processing target substrate, the supporting substrate, or the superposed substrate to the delivery unit, the reversing unit, and the joint unit.

5. The joint apparatus according to claim 3, further comprising:
in the processing container,
a reversing unit that reverses front and rear surfaces of the supporting substrate to be joined with the processing target substrate to which the adhesive has been applied and which has been heated to a predetermined temperature or the processing target substrate to be joined with the supporting substrate to which the adhesive has been applied and which has been heated to a predetermined temperature; and
a transfer unit that transfers the processing target substrate, the supporting substrate, or the superposed substrate to the delivery unit, the reversing unit, and the joint unit.

6. The joint apparatus according to claim 2,
wherein a plurality of the delivery units are arranged in a vertical direction.

7. The joint apparatus according to claim 3,
wherein a plurality of the delivery units are arranged in a vertical direction.

8. The joint apparatus according to claim 4,
wherein a plurality of the delivery units are arranged in a vertical direction.

9. The joint apparatus according to claim 1, further comprising:
a transfer unit, provided in the processing container, which transfers the processing target substrate, the supporting substrate, or the superposed substrate to the joint unit, and
wherein the superposed substrate temperature regulation unit is provided in the transfer unit,

10. The joint apparatus according to claim 9,
wherein the transfer unit includes a transfer arm in an almost disk shape, and
wherein the superposed substrate temperature regulation unit is the transfer arm in which a temperature regulation member is embedded.

11. The joint apparatus according to claim 9, further comprising:
a delivery unit for delivering the processing target substrate, the supporting substrate, or the superposed substrate to/from an outside of the processing container; and
a reversing unit that reverses :front and rear surfaces of the supporting substrate to be joined with the processing target substrate to which the adhesive has been applied and which. has been heated to a predetermined temperature or the processing target substrate to be joined with the supporting substrate to which the adhesive has been applied and which has been heated to a predetermined temperature,
wherein the transfer unit transfers the processing target substrate, the supporting substrate, or the superposed substrate also to the reversing unit,

12. The joint apparatus according to claim 11,
wherein a plurality of the delivery units are arranged in a vertical direction.

13. A joint system including a joint apparatus that joins a processing target substrate and a supporting substrate together,
the joint apparatus comprising:
a processing container that is capable of hermetically closing an inside thereof;
a joint unit that joins the processing target substrate and the supporting substrate together by pressing the processing target substrate and the supporting substrate via an adhesive; and
a superposed substrate temperature regulation unit that temperature-regulates a superposed substrate joined in the joint unit,
wherein the joint unit and the superposed substrate temperature regulation unit are arranged in the processing container,
the joint system comprising:
a joint processing station comprising the joint apparatus, a coating apparatus that applies the adhesive to the processing target substrate or the supporting substrate, a thermal processing apparatus that. heats the processing target substrate or the supporting substrate to which the adhesive has been applied to a predetermined temperature, and a transfer region for transferring the processing target substrate, the supporting substrate, or the superposed substrate to the coating apparatus, the thermal processing apparatus, and the joint apparatus; and
a transfer-in/out station that transfers the processing target substrate, the supporting substrate, or the superposed substrate in which the processing target substrate and the supporting substrate are joined together, into/out of the joint processing station.

14. A joint method of joining a processing target substrate and a supporting substrate together using a joint apparatus,
the joint apparatus comprising a processing container that is capable of hermetically closing an inside thereof, a joint unit that joins the processing target substrate and the supporting substrate together by pressing the processing target substrate and the supporting substrate via an adhesive, and a superposed substrate temperature regulation unit that temperature-regulates a superposed substrate joined in the joint unit,
wherein the joint unit and the superposed substrate temperature regulation unit are arranged in the processing container,
the joint method comprising:
a joint step of joining the processing target substrate to which the adhesive has been applied and which has been heated to a predetermined temperature and the supporting substrate together by pressing the processing target substrate and the supporting substrate in the joint unit; and
a temperature regulation step of temperature-regulating the superposed substrate in the superposed substrate temperature regulation unit after the joint step.

15. The joint method according to claim 14,
wherein a delivery unit for delivering the processing target substrate, the supporting substrate, or the superposed substrate to/from an outside of the processing container is provided in the processing container,
wherein the superposed substrate temperature regulation unit is provided in the delivery unit, and
wherein the temperature regulation step is performed in the delivery unit.

16. The joint method according to claim 15,
wherein the delivery unit includes a delivery arm in an almost disk shape,
wherein the superposed substrate temperature regulation unit is the delivery arm in which a temperature regulation member is embedded, and
wherein the temperature regulation step is performed while the superposed substrate is delivered by the delivery arm to the outside of the joint apparatus.

17. The joint method according to claim 15,
wherein in the processing container,
a reversing unit that reverses front and rear surfaces of the supporting substrate to be joined with the processing target substrate to which the adhesive has been applied and which has been heated to a predetermined. temperature or the processing target substrate to be joined with the supporting substrate to which the adhesive has been applied and which has been heated to a predetermined temperature, and
a transfer unit that transfers the processing target substrate, the supporting substrate, or the superposed. substrate to the delivery unit, the reversing unit, and the joint unit, are further provided,
wherein the joint method further comprises:
a reversing step of transferring the supporting substrate to which the adhesive has been applied and which has been heated to a predetermined temperature or the processing target substrate to which the adhesive has been applied and which has been heated to a predetermined temperature by the transfer unit from the delivery unit to the reversing unit, and reversing front and rear surfaces of the supporting substrate or the processing target substrate in the reversing unit, and
wherein in the joint step, the processing target substrate or the supporting substrate is transferred by the transfer unit from the reversing unit to the joint. unit, and the processing target substrate and the supporting substrate are joined together in the joint unit.

18. The joint method according to claim 14,
wherein a transfer unit that transfers the processing target substrate, the supporting substrate, or the superposed substrate to the joint unit is provided in the processing container,
wherein the superposed substrate temperature regulation unit is provided in the transfer unit, and
wherein the temperature regulation step is performed in the transfer unit

19. The joint method according to claim 18,
wherein the transfer unit includes a transfer arm in an almost disk shape,
wherein the superposed substrate temperature regulation unit is the transfer arm in which a temperature regulation member is embedded, and
wherein the temperature regulation step is performed while the superposed substrate is delivered by the delivery arm to the outside of the joint apparatus.

20. The joint method according to claim 18,
wherein in the processing container,
a delivery unit for delivering the processing target substrate, the supporting substrate, or the superposed substrate to/from an outside thereof, and
a reversing unit that reverses front and rear surfaces of the supporting substrate to be joined with the processing target substrate to which the adhesive has been applied and which has been heated to a predetermined temperature or the processing target substrate to be joined with the supporting substrate to which the adhesive has been applied and which has been heated to a predetermined temperature, are further provided,
wherein the transfer unit is capable of transferring the processing target substrate, the supporting substrate, or the superposed substrate also to the reversing unit,
wherein the joint method further comprises:
a reversing step of transferring the supporting substrate to which the adhesive has been applied and which has been heated to a predetermined temperature or the processing target substrate to which the adhesive has been applied and which has been heated to a predetermined temperature by the transfer unit from the delivery unit to the reversing unit, and reversing front and rear surfaces of the supporting substrate or the processing target substrate in the reversing unit, and
wherein in the joint step, the processing target substrate or the supporting substrate is transferred by the transfer unit from the reversing unit to the joint unit, and the processing target substrate and the supporting substrate are joined together in the joint unit.
